(19) United States
(12) Patent Application Publication
(10) Pub. No.: US 2008/0031357 A1
(43) Pub. Date: Feb. 7, 2008

(54) DECODING DEVICE, INFORMATION REPRODUCING APPARATUS AND ELECTRONIC APPARATUS

(75) Inventor: Tsunenori KIMURA, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/831,548

(22) Filed: Jul. 31, 2007

(30) Foreign Application Priority Data
Aug. 4, 2006 (JP) 2006-213746

(51) Int. Cl. H04B 1/66

(52) U.S. Cl. 375/240.25

(57) ABSTRACT

A decoding device decodes stream data including first data after first variable length encoding and second data after second variable length encoding in a stream form. The decoding device comprises: a presearch unit that, based on parameter data for each macroblock, analyzes a mode of the macroblock and performs first variable length decoding corresponding to the first variable length encoding to determine a starting address of a stream buffer in which the second data are stored; a parameter decode unit that decodes the first parameter data, based on parameter data after the first variable length decoding, to determine a parameter value of a target macroblock; and a data decode unit that performs second variable length decoding of the second data corresponding to the second variable length encoding; the data decode unit reading second data from the stream buffer based on the starting address from the presearch unit and performing the second variable length decoding of the second data.

The entire disclosure of Japanese Patent Application No. 2006-213746, filed Aug. 4, 2006 is expressly incorporated by reference herein.

### BACKGROUND OF THE INVENTION

1. Technical Field

The present invention relates to a decoding device, an information reproducing apparatus and an electronic apparatus.

2. Related Art

Moving picture experts group phase 4 (MPEG-4) and H.264/advance video coding (AVC) have been standardized as general-purpose encoding systems for image data of moving images.

In particular, H.264/AVC standard achieves higher compression coding efficiency than that of the existing coding systems such as MPEG-4 by reducing the processing unit of an image for motion compensation, increasing the number of reference frames, devising entropy coding, employing a deblocking filter and etc.

Moreover, H.264/AVC is adopted as the compression coding method for image data of moving images in digital terrestrial broadcasting.

H.264/AVC is growing more and more important.

This digital terrestrial broadcasting replaces existing analogue terrestrial broadcasting, and includes so-called “one segment broadcasting” as a service for portable terminals.

In “one segment broadcasting”, digital modulated waves modulated by a quadrature phase shift keying (QPSK) modulation technique are multiplexed by an orthogonal frequency division multiplexing (OFDM) modulation technique so that portable terminals can stably receive broadcasting during movement.

Thus, battery-operated cellular phones are required to have a high performance to perform more complex and high-level H.264/AVC processing.

Various schemes need be performed to achieve H.261/AVC processing.

For example, JP-A-7-123407 discloses a configuration in which a parallel variable length decoder is provided, wherein after decoded in parallel, two variable length codes are further decoded by a run-length decoder, and inverse discrete cosine transform is applied to the decoded data.

In the case of variable length decoding of stream data, the number of bits required for the latter stage of processing is determined according to the results of decoding.

That is, since information to specify a decoding method in the latter stage is included in stream data, the decoding method in the latter stage cannot be specified without decoding the stream data by a variable length decoder in the former stage of processing.

Regarding this point, in the technique disclosed in JP-A-7-7123407 mentioned above, although parallel decoding of two variable length codes can be performed by a parallel variable length decoder, decoding is performed by a run length decoder in the latter stage.

That is, since the parallel variable length decoder and the run length decoder do not operate in parallel, the high operation speed cannot be achieved.

Therefore, there has been a problem in that the technique disclosed in JP-A-7-123407 also needs to perform processing by a high-performance central processing unit, leading to high cost of devices that perform variable length decoding of stream data.

A variable length coding technique called context-based adaptive variable length coding (hereinafter abbreviated as CAVLC) is adopted in H.264/AVC standard.

The CAVLC, however, has a problem in that the processing is more complicated than that of the existing run length decoding, resulting in reduction of the speed of H.264/AVC decoding.

### SUMMARY

An advantage of some aspects of the invention is to provide a decoding device, an information reproducing apparatus and an electronic apparatus with which stream data decoded by variable length encoding can be made faster at low cost.

A decoding devise for decoding stream data including first data after first variable length encoding and second data after second variable length encoding in a stream form, according to a first aspect of the invention, which decoding device includes: a presearch unit that, based on parameter data for each macroblock, analyzes a mode of the macroblock and performs first variable length decoding corresponding to the first variable length encoding to determine a starting address of a stream buffer in which the second data are stored; a parameter decode unit that decodes the first parameter data, based on parameter data after the first variable length decoding, to determine a parameter value of a target macroblock; and a data decode unit that performs second variable length decoding of the second data corresponding to the second variable length encoding, the data decode unit reading second data from the stream buffer based on the starting address from the arch unit and performing the second variable length decoding of the second data.

In the decoding device according to the first aspect of the invention, the parameter decode unit and the data decode unit may operate in parallel after processing of the presearch unit.

In the decoding device according to the first aspect of the invention, the parameter decode unit may perform the first variable length decoding of data stored in the stream buffer and decode the first data based on parameter data after the first variable length decoding.

In any of the above-described cases, when stream data including first and second data each coded by variable length encoding in a stream form are decoded, a presearch unit is provided that determines the starting address of a stream buffer in which the second data are stored.

A data decode unit that receives the starting address from the presearch unit performs variable length decoding of the second data.

That is, regarding such stream data that the starting address of the second data is unclear unless the decoding result of the first data is made clear, the first data are roughly analyzed by the presearch unit and then information to identify the starting address of the second data is given to the data decode unit.

As a result, the data decode unit and the parameter decode unit can be operated in parallel.

Therefore, complicated decoding can be accomplished fast at low cost by using blocks having low performance.

The decoding device according to the first aspect of the invention further includes: an inverse quantizing unit that performs inverse quantization of data after the second variable length decoding; an inverse discrete cosine transform calculation unit that performs inverse discrete cosine transform of data output from the inverse quantizing unit; a prediction unit that performs one of inter-prediction and intra-prediction based on the parameter value; and an adding unit that adds a result of the prediction unit and a result of the inverse discrete cosine transform calculation unit.

In the device, the inverse quantizing unit, the inverse discrete cosine transform calculation unit, the prediction unit and the adding unit can operate in parallel to the parameter decode unit and the data decode unit.

According to the first aspect of the invention, a decoding device that performs decoding of image data can be operated fast at low cost.

In the decoding device according to the first aspect of the invention, the data decode unit may perform decoding of CAVLC.

According to the first aspect of the invention, a decoding device in accordance with H.264/AVC standard can be operated fast at low cost.

An information reproducing apparatus for reproducing at least one of picture data and sound data, according to a second aspect of the invention, includes: a division processing unit that extracts a first transport stream (TS) packet for generating picture data, a second TS packet for generating sound data, and a third TS packet other than the first and second TS packets from a transport stream: a memory having a first memory area in which the first TS packet is stored, and a second memory area in which the second TS packet is stored, and a third memory area in which the third TS packet is stored; a picture decoder that performs picture decoding for generating the picture data based on the first TS packet read from the first memory area; and a sound decoder that performs sound decoding for generating the sound data based on the second TS packet read from the second memory area.

In the apparatus, the picture decoder including the decoding device according to claim 1; the picture decoder reads the first TS packet from the first memory area independently of the sound decoder and performs the picture decoding based on the first TS packet; and the sound decoder reads the second TS packet from the second memory area independently of the picture decoder and performs the sound decoding based on the second TS packet.

According to the second aspect of the invention, an information reproducing apparatus can be provided that performs decoding having the heavy processing load using processing circuitry having low performance with low power consumption, in addition to the above-mentioned effects.

An electronic apparatus according to a third aspect of the invention includes the above-described information reproducing apparatus and a host that instructs the information reproducing apparatus to start at least one of the picture decoding and the sound decoding.

An electronic apparatus according to a fourth aspect of the invention includes: a tuner; the above-described information reproducing apparatus to which a transport stream from the tuner is supplied; and a host that instructs the information reproducing apparatus to start at least one of the picture decoding and the sound decoding.

According to any of the above aspects of the invention, an electronic apparatus can be provided that performs reproducing one segment broadcast with the heavy processing load with low power consumption, in addition to the above-mentioned effects.

### BRIEF DESCRIPTION OF THE DRAWINGS

The invention will be described with reference to the accompanying drawings, wherein like numbers reference like elements.

FIG. 1 is a block diagram of main portions of the configuration of a decoding device in the embodiment.

FIG. 2 is a block diagram of main portions of the configuration of a decoding device in a comparative example of the embodiment.

FIG. 3 is an explanatory diagram showing operation examples of a decoding device in the comparative example.

FIG. 4 is an explanatory diagram of operation examples of a decoding device in the embodiment.

FIG. 5 is a block diagram of a configuration example of a decoding device that performs decoding in accordance with H.264/AVC standard.

FIG. 6 is a flow chart of a processing example of the decoding device 500 in FIG. 5.

FIG. 7 is a flow chart of one example of header analyzing by the parameter analysis unit 530.

FIG. 8 is a flow chart of one example of processing of the CAVLC unit.

FIGS. 9A, 9B and 9C are explanatory views of CAVLC calculating.

FIGS. 10A, 10B and 10C are explanatory views of Golomb coding.

FIG. 11 is a flow chart of an operation example of the CAVLC unit.

FIG. 12 is an explanatory view of processing of the inverse quantizing unit.

FIGS. 13 and 14 are a flow chart of an operation example of the variable length decoding (VLD) presearch unit in FIG. 1.

FIG. 15 is a flow chart of an example of processing of the macroblock (MB) parameter decode unit.

FIG. 16 is a flow chart of an example of processing of intra prediction mode process in FIG. 15.

FIGS. 17 to 20 are a flow chart of an example of processing of motion vector computing process in inter prediction mode in FIG. 15.

FIG. 21 is a block diagram of main portions of the configuration of a decoding device in a modification of the embodiment.

FIG. 22 is a block diagram of a hardware configuration example of a decoding device in the embodiment.

FIG. 23 is an explanatory view of the concept of segments of digital terrestrial broadcasting.

FIG. 24 is an explanatory view of a TS.

FIG. 25 is an explanatory view of a packetized elementary stream (PES) packet and a section.

FIG. 26 is a block diagram of a configuration example of a cellular phone including a multimedia central processing unit (CPU) in the comparative example of the embodiment.

FIG. 27 is a block diagram of a configuration example of a cellular phone including an information reproducing apparatus in the embodiment.

FIG. 28 is a block diagram of a configuration example of an image information integrated circuit (IC) of the embodiment.

FIG. 29 is an explanatory view of operations of the image information IC of FIG. 28.

FIG. 30 is a flow chart of an operation example of reproducing of a host CPU.

FIG. 31 is a flow chart of an operation example of broadcasting reception starting of FIG. 30.

FIG. 32 is an explanatory view of operations in broadcasting reception starting of an image information IC.

FIG. 33 is a flow chart of a processing example of the broadcast reception finishing of FIG. 30.

FIG. 34 is an explanatory view of operations in broadcasting reception finishing of an image information IC.

FIG. 35 is a flow chart of an operation example of a picture decoder.

FIG. 36 is an explanatory view of operations of a picture decoder of an image information IC.

### DESCRIPTION OF EXEMPLARY EMBODIMENT

An embodiment of the invention will be described below with reference to the accompanying drawings.

It should be noted that the embodiment described below does not limit the scope of the invention defined by the appended claims.

All the features described below are not necessarily essential elements of the invention.

1. Decoding Device

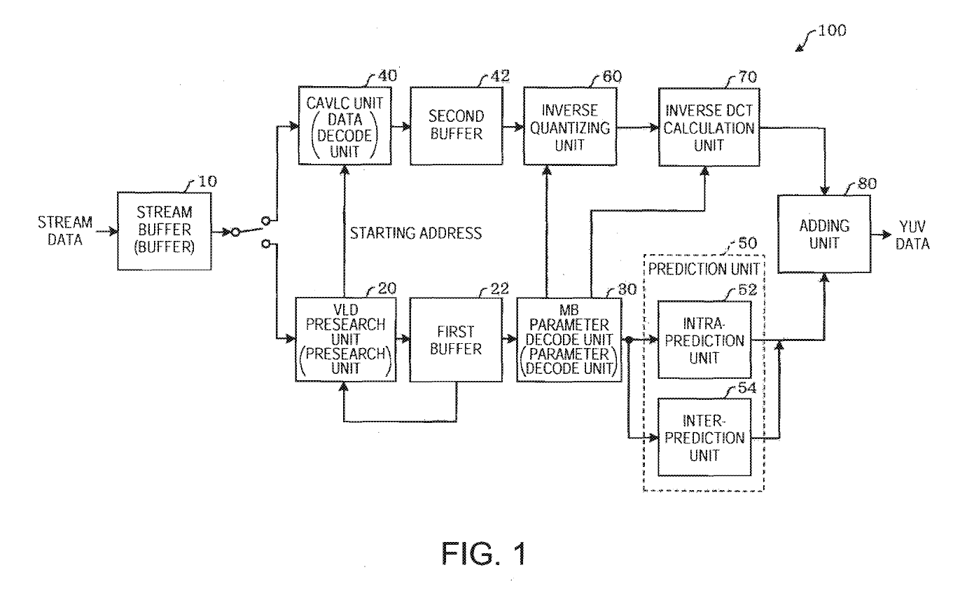

FIG. 1 is a block diagram of main portions of the configuration of a decoding device according to the present embodiment.

Note that a decoding device 100 is not intended to be limited to the configuration shown in FIG. 1, and various modifications such as omitting part of components and adding other components may be made.

Input to the decoding device 100 are stream data, and the decoding device 100 performs decoding of the stream data.

The stream data include parameter data after first variable length encoding (first data) and image data after second variable length encoding (second data) in a stream form.

The decoding device 100 performs decoding image data that have been encoded while decoding parameter data required for decoding the encoded image data.

More specifically, the decoding device 100 includes a stream buffer 10, a VLD presearch unit (a presearch unit in the general meaning) 20, an MB parameter decode unit (a parameter decode unit in the general meaning) 30, and a CAVLC unit (a data decode unit in the general meaning) 40.

The term “MB” as used herein refers to a block defined by a given number of pixels in the horizontal direction and a given number of lines in the vertical direction of an image.

Stream data are stored in the stream buffer 10.

Based on parameter data for each MB, the VLD presearch unit (presearch unit in the general meaning) 20 analyzes the mode of the MB and performs first variable length decoding corresponding to the first variable length encoding to determine the starting address of a storage area of the stream buffer 10 in which image data are stored.

The MB parameter decode unit 30 decodes parameter data, based on the parameter data after the first variable length decoding, to determine a parameter value of the target MB.

The parameter value of the target MB is used for decoding of image data of the target MB.

That is, decoding of image data changes according to the parameter value.

The CAVLC unit 40 performs second variable length decoding of image data corresponding to the second variable length encoding.

At this point, the CAVLC unit 40 reads image data from the stream buffer 10 based on the starting address of the stream buffer 10 from the VLD presearch unit 20, and the image data are decoded by the second variable length decoding.

The decoding device 100 as described above may further include first and second bluffers 22 and 42, a prediction unit 50, an inverse quantizing unit 60, an inverse discrete cosine transform (DCT) operation unit 70 and an adding unit 80).

The prediction unit 50 includes an intra-prediction unit 52 and an inter-prediction unit 54.

Data after the first variable length decoding performed by the VLD presearch unit 20 are stored in the first buffer 22.

The VLD presearch unit 20 updates the starting address of the stream buffer 10, which indicates the starting position of the storage area of the stream buffer 10 in which image data are stored, while referring data after the first variable length decoding stored in the first buffer 22, and notifies the CAVLC unit 40 of the starting address after processing.

Data after the second variable length decoding performed by the CAVLC unit 40 are stored in the second buffer 42.

The second buffer 42 has a buffering function required for variable length decoding.

Data stored in the second buffer 42 are offered for processing of the inverse quantizing unit 60.

The inverse quantizing unit 60 receives a parameter value (e.g. quantizing parameter) from the MB parameter decode unit 30, and performs, using the parameter value, a known inverse quantization of the data stored in the second buffer 42.

The inverse DCT calculation unit 70 receives a parameter value (e.g. block size) from the MB parameter decode unit 30, and performs, using the parameter value, a known inverse DCT of the data from the inverse quantizing unit 60.

On the other hand, the prediction unit 60 receives a parameter value (e.g. information indicating an intrablock or an interblock) from the MB parameter decode unit 30 and does intra-prediction or inter-prediction.

The intra-prediction unit 52 determines a prediction value for intra-picture encoding.

The inter-prediction unit 54 determines a prediction value for inter-picture encoding.

The adding unit 80 adds data from the inverse DCT calculation unit 70 and data from the intra-prediction unit 52 or the inter-prediction unit 54, and outputs the resulting data as YUV data.

In the decoding device 100, data stored in the stream buffer 10) are supplied to either the VLD presearch unit 20 or the CAVLC unit 40, and are never supplied to both blocks simultaneously.

As described above, in the embodiments regarding such stream data that the starting address of the image data is unclear unless the decoding result of parameter data is made clear, the parameter data are roughly analyzed by the VLD presearch unit 20 and thereafter information to identity the starting address of the image data is given to the CAVLC unit 40.

As a result, the MB parameter decode unit 30 that determines a parameter value by decoding parameter data in detail and the CAVLC unit 40 that decodes image data can be operated in parallel.

Therefore, complicated decoding can be accomplished fast at low cost by using blocks having low performance.

### 1.1 Comparison to Comparative Example

Effects in the embodiment will now be described with comparison with a comparative example of the embodiment.

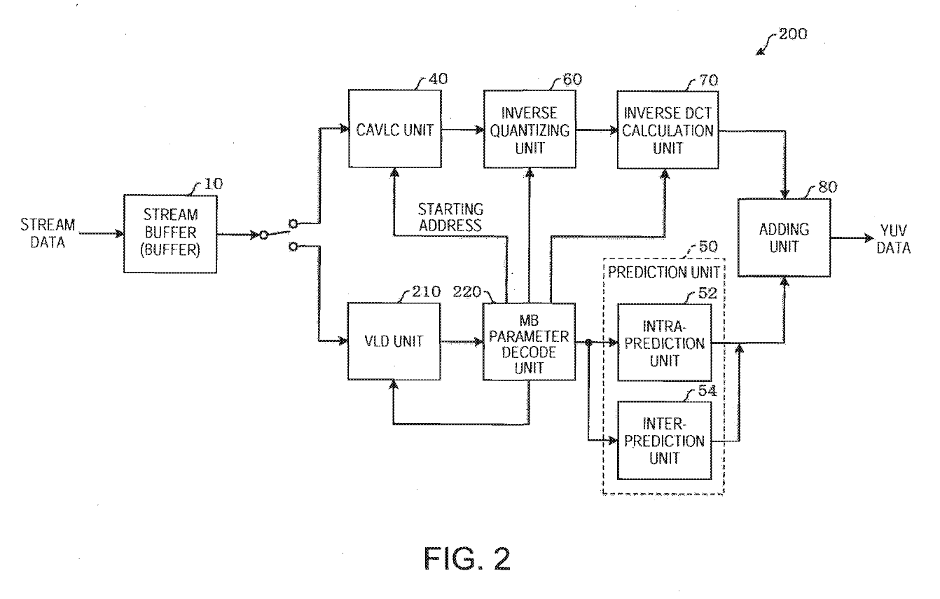

FIG. 2 is a block diagram of main portions of the configuration of a decoding device in a comparative example of the embodiment.

Note that such components as are found in FIG. 1 are indicated by the same reference numerals and the common explanation is suitably omitted.

In a decoding device 200 in the comparative example, a VLD unit 210 is provided instead of the VLD presearch unit 20 and an MB parameter decode unit 220 is provided instead of the MB parameter decode unit 30, as compared with the decoding device 100 in FIG. 1.

In the decoding device 200, the first and second buffers 22 and 42 are omitted and the starting address is supplied to the CAVLC unit 40 from the MB parameter decode unit 220.

The VLD unit 210 outputs data obtained after Golomb decoding of parameter data, which will be described later, to the MB parameter decode unit 220.

In the decoding device 100 shown in FIG. 1, the Golomb decoding is performed in the VLD presearch unit 20.

The MB parameter decode unit 220 performs calculation to determine a motion vector value, calculation to determine an intra-mode value and an inter-mode value, calculation to determine a quantizing parameter, calculation to determine a macroblock type, and the like for data from the VLD unit 210.

As a result of decoding the parameter data by the MB parameter decode unit 220, the starting address of the stream buffer 10, in which second data to be referred to by the CAVLC unit 40 are stored, is determined, and the MB parameter decode unit 220 notifies the CAVLC unit 40 of the starting address.

The CAVLC unit 40 reads image data from the stream buffer 10 by using the starting address from the MB parameter decode unit 220, and the image data are processed using CAVLC.

In the decoding device 200 in FIG. 2, supplied to the VLD unit 210 is the starting address from the MB parameter decode unit 220.

Different from this, part of the above-mentioned processing performed by the MB parameter decode unit 220 is performed by the VLD presearch unit 20 in the decoding device 100 in FIG. 1.

That is, in the VLD presearch unit 20, processing to determine the starting address of image data required for processing of image data by the CAVLC unit 40 is performed, which is part of processing on parameter data.

This processing to determine the starting address of image data corresponds to part of the processing performed by the MB parameter decode unit 220.

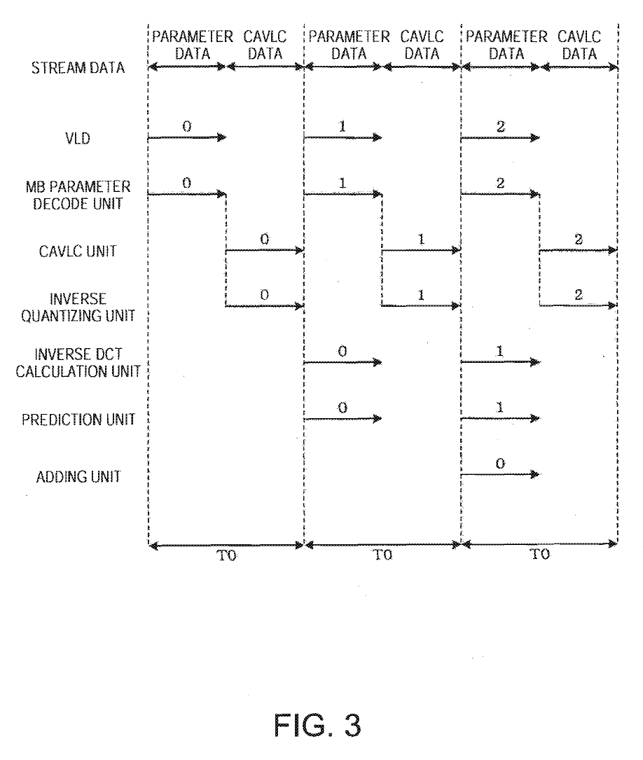

FIG. 3 is an explanatory diagram showing operation examples of the decoding device 200 in the comparative example.

In FIG. 3, in the case of stream data in which parameter data and CAVLC data as image data are multiplexed, data processed in each unit of the decoding device 200 are illustrated for each MB.

For example, in the figure, the VLD unit 210 and the MB parameter decode unit 220 perform processing of an MB with the MB number of “0”, and after the processing finishes, the CAVLC unit 40 and the inverse quantizing unit 60 performs processing of CAVLC data with the MB number of “0”.

Subsequently, the VLD unit 210 and the MB parameter decode unit 220 perform processing of an MB with the MB number of “1” that follows “0”, and after the processing finishes, the CAVLC unit 40 and the inverse quantizing unit 60 perform processing of the CAVLC data with the MB number of “1”.

In the decoding device 200, since processing of the CAVLC unit 40 is performed after processing of the MB parameter decode unit 220 as described above, reduction of processing time in each unit of the decoding device 200 does not reduce a unit processing time TO so much.

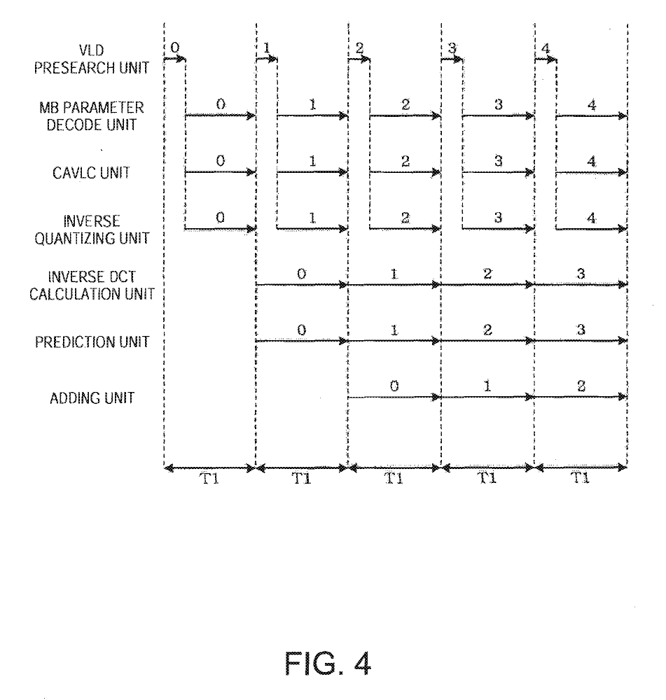

FIG. 4 is an explanatory diagram of operation examples of the decoding device 100 in the embodiment.

In FIG. 4, like FIG. 3, in the case of stream data in which parameter data and CAVLC data as image data are multiplexed, data processed in each unit of the decoding device 100 are illustrated for each MB.

In the embodiment, first, the VLD presearch unit 20 decodes parameters required for the CAVLC unit 40, which are included in parameter data.

As a result, the VLD presearch unit 20 notifies the CAVLC unit 40 of the starting address of the storage area of the stream buffer 10 in which e.g., CAVLC data are stored.

Then, the MB parameter decode unit 30, the CAVLC unit 40 and the inverse quantizing unit 60 operate in parallel for the CAVLC data and parameter data with an MB number of “0”.

Subsequently, for an MB with an MB number of “1” that follows “0”, the VLD presearch unit 20 notifies the CAVLC unit 40 of the starting address of the storage area of the stream buffer 10 in which CAVLC data are stored.

Then, the MB parameter decode unit 30, the CAVLC unit 40 and the inverse quantizing unit 60 can operate in parallel for the CAVLC data and parameter data with the MB number of “1”.

At this point, the inverse DCT calculation unit 70 and the prediction unit 50 process the parameter data and CAVLC data with the previous MB number of “0”, performing pipeline operations.

Subsequently, for an MB with an MB number of “2” that follows “1”, the VLD presearch unit 20 notifies the CAVLC unit 40 of the starting address of the storage area of the stream buffer 10 in which CAVLC data are stored.

Then, the MB parameter decode unit 30, the CAVLC unit 40 and the inverse quantizing unit 60 can operate in parallel for the CAVLC data and parameter data with the MB number “2”.

At this point, the inverse DCT calculation unit 70 and the prediction unit 50 process the parameter data and CAVLC data with the previous MB number of “1” performing pipeline operations.

The adding unit 80 perform addition of the data with the MB number of “0”.

That is, the MB parameter decode unit 30 and the CAVLC unit 40 operate in parallel after processing of the VLD presearch unit 20.

The inverse quantizing unit 60, the inverse DCT calculation unit 70, the prediction unit 50 and the adding unit 80 also operate in parallel to the MB parameter decode unit 30 and the CAVLC unit 40.

As described above, in the embodiment, the parameter value required for the CAVLC unit is calculated in the VLD presearch unit 20.

Therefore, at least the CAVLC unit 40 and the MB parameter decode unit 30 operate in parallel in the embodiment.

Pipelining operations are performed by the CAVLC unit 40 and the MB parameter decode unit 30 together with the prediction unit 50.

Thus, processing of the VLD unit 210 waits to terminate until processing of the MB parameter decode unit 220 ends in the comparative example, whereas the VLD presearch unit 20 needs not to await the end of processing of the MB parameter decode unit 30 in the embodiment.

Further, the parameter value to be decoded in the MB parameter decode unit 30 can be reduced.

As a result, a unit processing time T1 as the pipelining time can be made shorter than the unit processing time T0 in FIG. 3.

### 1.2 H.264/AVC

Next, a decoding device that performs decoding in accordance with H.264/AVC, to which the decoding device 100 in the embodiment is applicable, will be described.

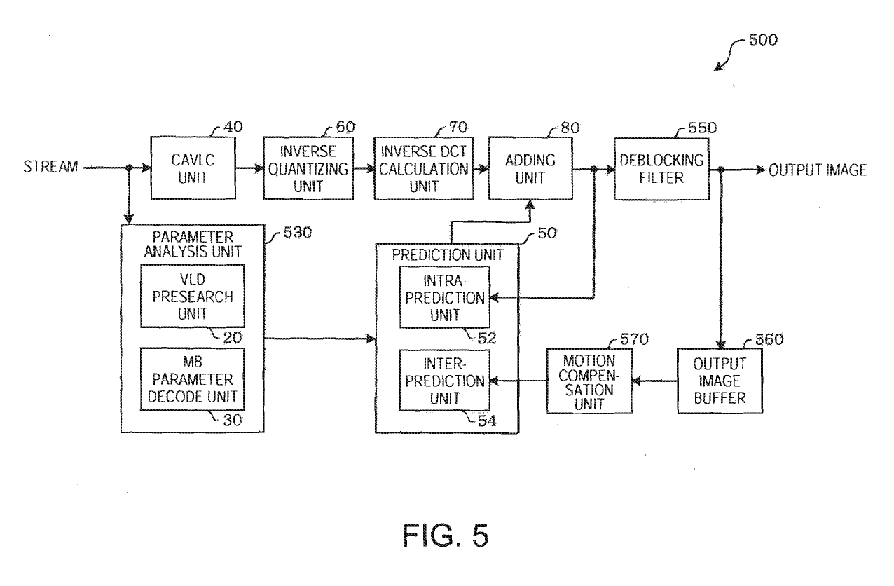

FIG. 5 is a block diagram of a configuration example of a decoding device that performs decoding in accordance with H.264/AVC, to which the embodiment is applicable.

Note that such components as are found in FIG. 1 are indicated by the same reference numerals and the common explanation is suitably omitted.

In FIG. 5, components that correspond to the stream buffer 10, the first and second buffers 22 and 42 in FIG. 1 are not shown.

In FIG. 5, a decoding device is designed to implement a series of decoding processes of H.264/AVC standard for data using 1 MB as the data block unit.

More specifically, the decoding device 500 decodes stream data encoded by an entropy coding method according to H.264/AVC standard and thereafter generates inverse-quantized data.

The decoding device 500 includes a parameter analysis unit 530, a deblocking filter 550, an output image buffer 560 and a motion compensation unit 570.

The parameter analysis unit 530 includes the VLD presearch unit 20 and the MB parameter decode unit 30 in FIG. 1.

The deblocking filter 550 reduces block noise.

Image data after decoding are buffered into the output image buffer 560.

The motion compensation unit 570 performs motion compensation for motion estimation.

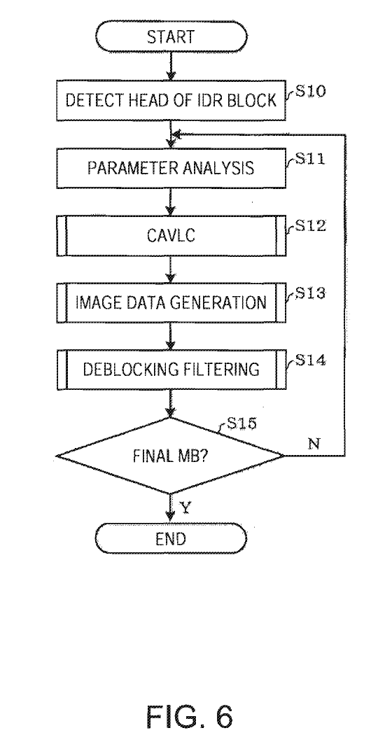

FIG. 6 is a flow chart of a processing example of the decoding device 500 in FIG. 5.

In the decoding device 500, the head of an instantaneous decoding refresh (IDR) block is detected (step S10).

The IDR block is a block for decoding without referring to the past pictures to achieve a random access function.

Next, in the decoding device 500, a predetermined data unit is read from the stream data and parameter analysis required for decoding is performed, so that parameters (motion vector information) and the like required for extraction of bit data for generating image data and motion estimation are determined (step S11).

Then, the CAVLC unit 40a performs processing of CAVLC to decode stream data coded by the entropy coding method (step S12).

Then, for the data inverse-quantized by the inverse quantizing unit 60, the inverse DCT calculation unit 70 performs inverse-DCT calculation to generate motion-estimated or motion-compensated image data (step S13).

The image data generated in step S13 are processed to reduce the block noise by the deblocking filter 550, and are output as the image data of an output image (step S14).

It is determined whether or not the target MB is the final MB obtained by finally dividing an image (step S15).

If the MB is the final MB (step S15: Y), then the process ends, whereas if the MB is not the final MB (step S15: N), the process returns to step S11.

1.2.1 CAVLC Process

In the decoding device 500, a header analyzing process for extracting parameters from stream data, a CAVLC process for decoding data that have been extracted from the stream data coded by an entropy coding method, and an inverse-quantizing process are performed.

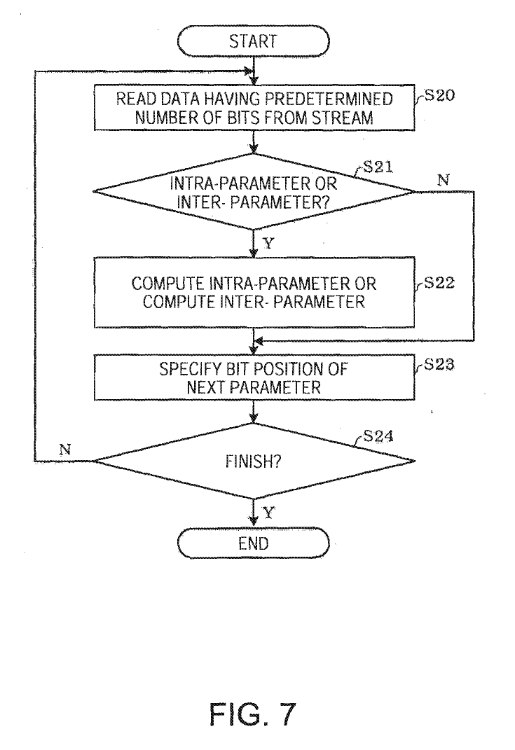

FIG. 7 is a flow chart of one example of header analyzing by the parameter analysis unit 530.

When reading stream data from a stream buffer, the parameter analysis unit 530 reads data having a predetermined number of bits from stream data stored in the stream buffer (not shown in FIG. 5) (step S20).

The parameter analysis unit 530 determines whether or not the data read in step S20 are the parameter for intra-prediction or the parameter for inter-prediction (step S21).

As a result, if the data are the parameter for intra-prediction or the parameter for inter-prediction (step S21: Y), then the parameter for intra-prediction or the parameter for inter-prediction is computed (step S22).

If the data are not the parameter for intra-prediction or the parameter for inter-prediction (step S21: N), or if the parameter for intra-prediction or the parameter for inter-prediction is computed, then the bit position of the next parameter is found (step S23).

This means that information on identifying the kind and the data size of a parameter is set in stream data and therefore the stream data need to be analyzed sequentially from the top.

Thus, with the next bit position specified, if the header analysis finishes (step S24: Y), the process ends.

Alternatively, if the header analysis is continued (step S24: N), the process returns to step S20 to read data having the next predetermined number of bits from the stream data.

For example, in the process of detecting the head of IDR block and in the process of parameter analysis after the detecting process in FIG. 6, the units perform processing while accessing the stream data, as described above.

When the header analysis as described above is performed, the bit position of image data to be decoded can be specified, and decoding in the CAL unit 40 is started.

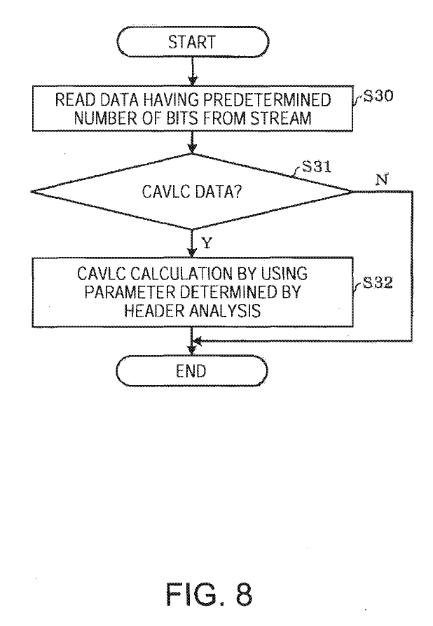

FIG. 8 is a flow chart of one example of processing of the CAVLC unit 40.

The CAVLC unit 40 reads data having a predetermined number of bits from stream data stored in the stream buffer (step S30).

The CAVLC unit 40 determines whether or not data read in step S30 are CAVLC data (step S31).

Here, the term “CAVLC data” means the data coded by CAVLC.

If the data are the CAVLC data (step S31: Y), then CAVLC calculating is performed by using a parameter determined by the header analysis in FIG. 7 (step S32), and the process ends.

Note that if it is determined that the data are not the CAVLC data (step S31: N), the process ends.

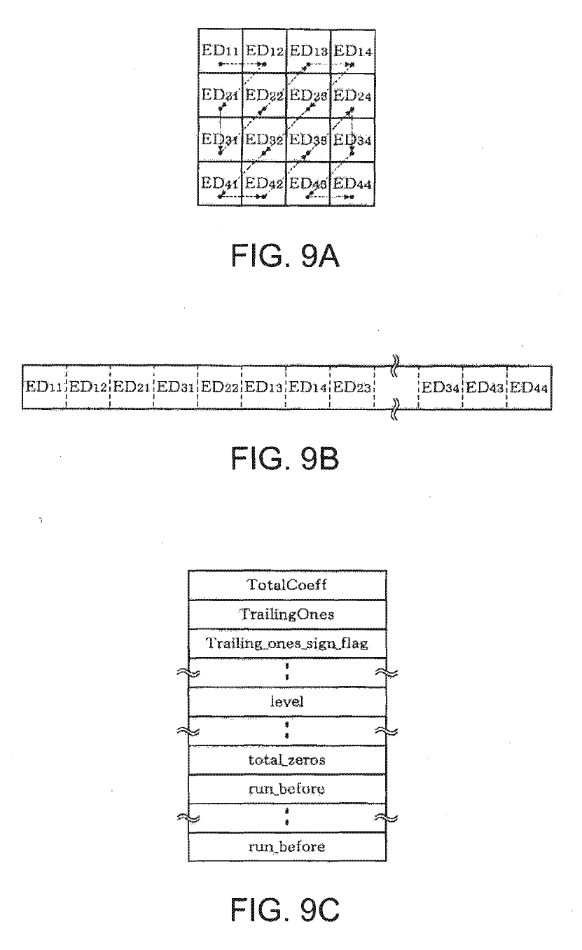

FIGS. 9A, 9B and 9C are explanatory views of CAVLC calculating.

FIG. 9A shows DCT quantized coefficient values ED₁₁, ED₁₂, ED₁₃ . . . ED₄₄ of data blocks of four pixels in the horizontal direction and four lines in the vertical direction of an image.

In encoding the stream data, data are one-dimensionally encoded in the order of FIG. 9A, so that a sequence of data is generated as shown in FIG. 9B.

Then, the sequence of data of FIG. 9B is encoded by the entropy coding method, and thus stream data are generated.

More specifically, data are coded by sequentially storing parameter values indicated in FIG. 9C.

FIG. 9C, indicated by “TotalCoeff” is “the number of non-zero coefficients” Of the sequence of data.

Indicated by “TrailingOnes” is “the number of consecutive coefficients having an absolute value equal to 1 at the end” of the sequence of data of FIG. 9B.

Indicated by “Trailing_ones_sign_flag” is “the code of consecutive coefficients having an absolute value equal to 1 at the end” of the sequence of data of FIG. 9B.

Indicated by “level” is “the quantized DCT coefficient value” of the sequence of data of FIG. 9B.

Indicated by “total_zeros” is “the number of zero-valued coefficients that are located before the position of the last non-zero coefficient” of FIG. 9B.

Indicated by “run_before” is “the number of consecutive zeros before the coefficient value” in FIG. 9B.

The data decoded by the CAVLC unit 40 as described above are further encoded by Golomb coding.

Therefore, the CAVLC unit 40 is designed to be able to decode the data that have been encoded by Golomb coding.

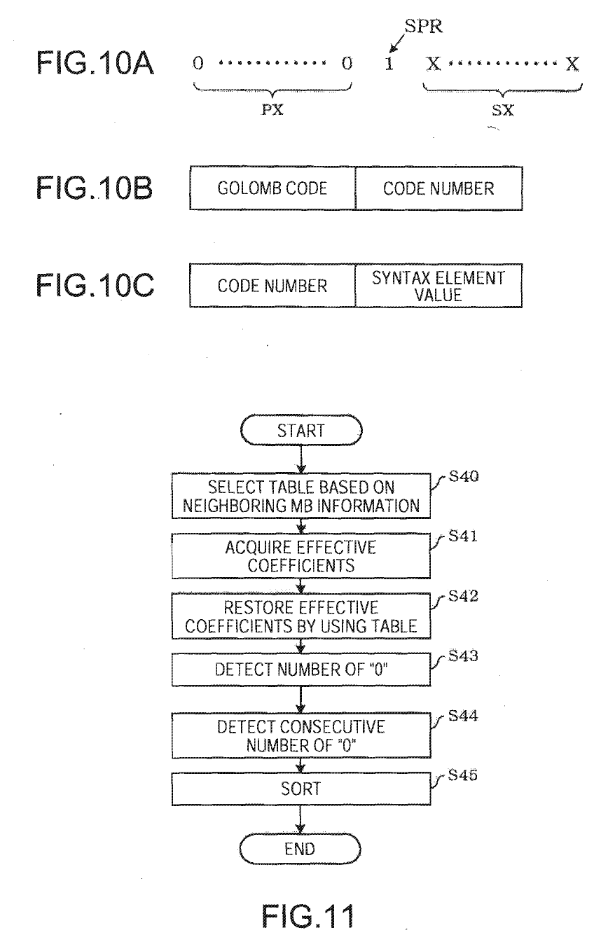

FIGS. 10A, 10B and 10C are explanatory views of Golomb coding.

Like CAVLC, Golomb coding is an encoding method adopted in H.264/AVC standard.

A Golomb code is constructed in two parts: a prefix part PX and a suffix part SX, with a separater SPR “1” as the boundary therebetween, as shown in FIG. 10A.

A predetermined number of “0” continues in the prefix part PX, and the same number of “0” or “1”, as in the prefix part PX is included in the suffix part SX in accordance with the data to be encoded.

Here, the Golomb code shown in FIG. 10A is assigned to a code number in accordance with a table shown in FIG. 10B.

Furthers the code number shown in FIG. 10B is assigned to a syntax element value in accordance with the table shown in FIG. 10C.

The CAVLC unit 40 analyzes parameterized numerical values as shown in FIG. 9C and converts the values into the sequence of data shown in FIG. 9B.

The CAVLC unit 40 can generate a group of quantized DCT coefficient values as shown in FIG. 9A.

At this point, the CAVLC unit 40 decodes the decoded data based on the Golomb code determined in accordance with the table shown in FIG. 10C and the table shown in FIG. 10B.

FIG. 11 is a flow chart of an operation example of the CAVLC unit 40.

First, the CAVLC unit 40 selects the above-described tables based on information on the neighboring MBs of the target MB.

That is, the CAVLC unit 40 selects tables for decoding by using an average value of effective coefficients of MBs located above the target MB in the vertical direction and MBs located left to the target MB in the horizontal direction of an image.

Subsequently, the CAVLC unit 40 issues a get request with a predetermined number of request bits to e.g., a data access circuit for accessing a stream buffer and acquires effective coefficients of the target MB (step S41).

When receiving the get request, the data access circuit accesses the stream buffer and performs control to supply bit data if a predetermined number of bits are not present in the internal buffer.

Thus, when data having a predetermined number of bits are obtained, the CAVLC unit 40 determines whether or not “non-zero coefficients” are present among coefficients of the target MB while returning unnecessary bits by using an unget request through the data access circuit.

As a result, the read pointer of the stream buffer that the data access circuit maintains and that advances by read access can be restored to the original state.

The CAVLC unit 40 issues a get request with a predetermined number of request bits to the data access circuit again and the effective coefficients are restored as described above using a table selected in step S40 (step S42), while returning unnecessary bits by using an unget request through the data access circuit.

The CAVLC unit 40 issues a get request with a predetermined number of request bits to the data access circuit further again, and detects the number of “0 coefficients” (step S43), while returning unnecessary bits by using an unget request through the data access circuit.

Next, the CAVLC unit 40 issues a get request with a predetermined number of request bits to the data access circuit again, and detects the number of consecutive “0 coefficients” (step S44), while returning unnecessary bits by using an unget request through the data access circuit.

Finally, the CAVLC unit 40 issues a get request with a predetermined number of request bits to the data access circuit, and sorts the various detected data along the direction of zig-zag scan shown in FIG. 9A to restore entropy coded coefficients, thereby generating data in the unit of MB (step S45).

Thus, the process ends.

When the encoded stream data by an entropy coding method are decoded as described above, the decoded data are input to the inverse quantizing unit 60.

1.2.2 Inverse-Quantizing

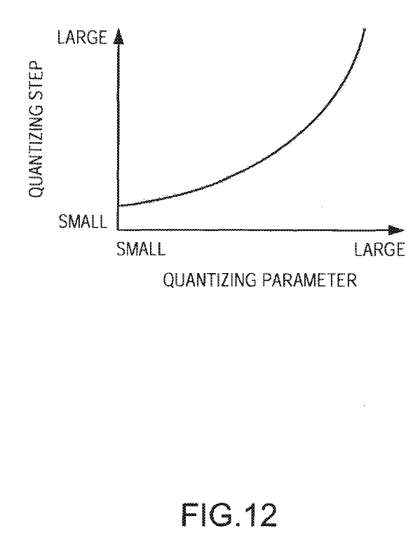

FIG. 12 is an explanatory view of processing of the inverse quantizing unit 60.

The above-mentioned DCT coefficient values are the values that result from division by the quantizing step and that are rounded off to integers.

Therefore, the inverse quantizing unit 60 multiplies the DCT coefficient values resulting from the above-described decoding by the quantizing step to generate data to be supplied to the inverse DCT calculation unit 70.

At this point, it is desirable that the quantizing step be determined in accordance with the characteristics shown in FIG. 12.

In FIG. 12, with the quantizing parameter in the horizontal axis and the quantizing step in the vertical axis, the quantizing parameter and the quantizing step have nonlinearity.

More specifically, if a quantizing parameter is given as a DCT coefficient value, the quantizing step is determined in accordance with the characteristics shown in FIG. 12.

Further specifically, the quantizing step is derived such that the quantizing parameter and the logarithm of quantizing step are proportional to each other.

By using the quantizing step and the quantizing parameter, data to be supplied to the inverse DCT calculation unit 70 are generated.

1.2.3 Generation of Image Data

In FIG. 5, the inverse DCT calculation unit 70 performs a known inverse DCT calculation prescribed by H.264/AVC standard on the data from the inverse quantizing unit 60.

At this point, in the parameter analysis unit 530, analysis of parameters for intra-pre diction or parameters for inter-prediction of the data of the target MB has already been completed.

In the prediction unit 503 it is specified in accordance with the analysis result of the parameter analysis unit 530 whether the intra-picture prediction or inter-frame prediction is to be done.

If the intra-picture prediction is done, the intra-pre diction unit 52 of the prediction unit 50 performs a known intra-picture prediction process in the target frame based on the output result of the adding unit 80.

On the other hand, the motion compensation unit 570 performs a known motion compensation prescribed by H.264/AVC standard using a reference frame of the frame analyzed by the parameter analysis unit 530 among a plurality of reference frames stored in the output image buffer 560.

If inter-flame prediction is done based on the analysis result of the parameter analysis unit 530, the inter-prediction unit 54 does a known inter-picture prediction process prescribed by H.264/AVC standard.

Thus, data for which motion estimation or motion compensation has been performed are added to the data after inverse DCT calculation in the adding unit 80.

The deblocking filter 550 performs, by MB, a process to reduce block noise (deblocking filtering process) of image data for which motion estimation or motion compensation has been performed.

When the deblocking filtering process is completed, the processed image data are output as the image data of the output image while being buffered into the output image buffer 560.

The image data in the output image buffer 560 are to be used for motion compensation and motion estimation for generating image data of the next image.

The deblocking filter 550 can reduce block noise of at least one of a block boundary and a macroblock boundary.

As this process, a known deblocking filter process prescribed by H.264/AVC standard can be adopted.

The deblocking filter process as described above eliminates decoding by using a reference image with much block noise, resulting in reducing propagation of block noise.

This can contribute to achieving higher image quality of a decoded image.

### 1.3 Operations of Main Portions of the Embodiment

Next, operations of main portions of the embodiment that is applied to the decoding device 500 in FIG. 5 (the decoding device 100 in FIG. 1) will be described in detail.

1.3.1 VLD Presearch Unit

The VLD presearch unit 20 in the embodiment decodes only the parameter data indicated below among parameter data required for the decoding process of H.264/AVC; so as to determine the starting address of the stream buffer 10 in which CAVLC data that follows the parameter data are stored.

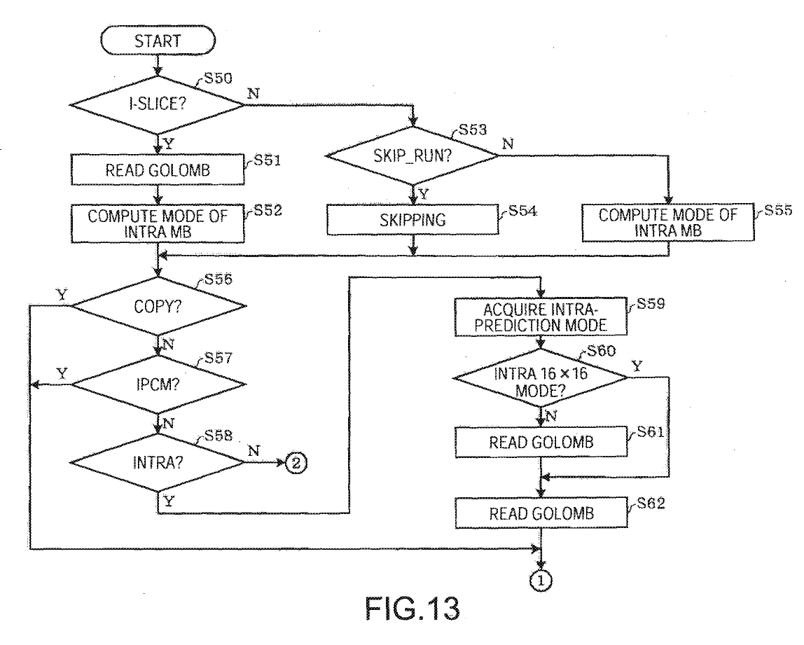

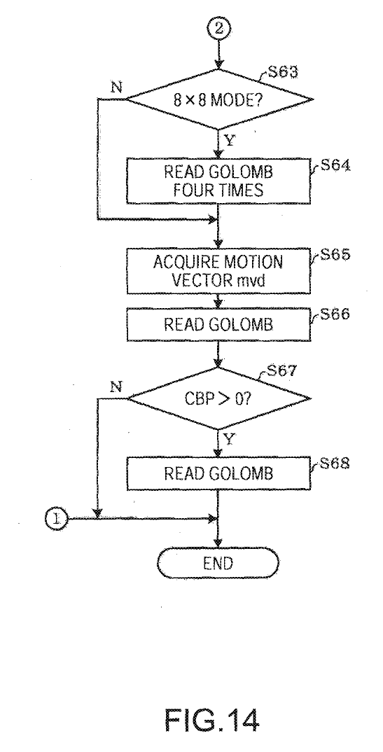

FIGS. 13 and 14 are a flow chart of an operation example of the VLD presearch unit 20 in FIG. 1.

First, the VLD presearch unit 20 determines whether or not the target MB is I-slice (step S50).

If the target MB is I-slice (step S50: Y), then extra data having a predetermined number of bits are read from the stream buffer 10 and the data are decoded by Golomb decoding, and thereafter bits that become unnecessary as a result of the Golomb decoding are returned as described above (step S51).

Hereinafter, the process of the step S51 refers to as the read Golomb process.

The type of MB is determined by the data decoded by Golomb decoding and the mode of an intra-MB is computed (step S52).

On the other hand, if the target MB is not I-slice (step S50: N), then it is determined whether or not the target MB, is an MB, to be skipped such as an MB having no data to be decoded (step S53).

If the target MB is an MB is to be skipped (step S53: A), then predetermined skipping is performed (step S54).

If the target MB is not an MB to be skipped (step S53: N), then the inter MB mode is computed (step S55).

Subsequently to steps S52, 54 and 55, it is determined whether or not the target MB is in copy mode (whether or not the target MB only copies between MBs) (step S56).

If the target MB is in copy mode (step S56: Y), the process ends.

If the target MB is not in copy mode (step S56: N), then it is determined whether or not the target MB is in IPCM mode (whether or not the target MB is the data that have not been coded) (step S57).

If the target MB is in IPCM mode (step S57: Y), the process ends.

Alternatively, if the target MB is not in IPCM mode (step S57: N), then it is determined whether or not the target MB is in INTRA mode (step S58).

If it is determined that the target MB is in INTRA mode (step S58: Y) then the intra prediction mode is acquired (step S59).

Thereafter, it is determined whether or not the mode is intra 16×16 mode (step S60), and if the mode is not intro 16×16 mode (step S60: N), then the read Golomb process is performed so as to acquire a code block pattern (CBP) indicating which block of the MB an IDCT (inverse DCT) coefficient (AC transform data) is present in (step S61).

If the mode is intra 16×16 mode (step S60: Y), or next to step S61, the read Golomb process is performed to acquire a quantizing parameter (step S62).

Thus, the process ends.

If the target MB is not in INTRA mode (step S58: N), then it is determined whether or not the mode is 8×8 mode (step S03).

If the mode is 8×8 mode (step S63: T), then the mode of each block is acquired by performing the read Golomb process four times (step S64).

If that the mode is not 8×8 mode (step S63: N), or next to step S64, then the read Golomb process is performed to acquire decoded motion vector information mvd (step S65), and then the read Golomb process is performed to acquire the CBP (step S66).

If the CBP is larger than 0 (step S67: Y), then it is determined which block in the target MB the IDCT coefficient is present in, and the read Golomb process is performed so that a quantizing; parameter is acquired (step S08).

Thus, the process ends.

If the CBP is not larger than 0 (step S67: N), it is determined that the IDCT coefficient is not present in any block of the target MB, and thus the process ends.

As described above, data of accessed target MB are decoded by read Golomb processes and the like.

After the processes have been completed, the address indicated by the read pointer of the stream buffer 10 is supplied as the starting address of CAVLC data to the CAVLC unit 40.

1.3.2 MB Parameter Decode Unit

As shown in FIGS. 13 and 14, parameter data obtained by accessing the stream buffer 10 are decoded simply by the VLD presearch unit 20 to compute the starting address of CAVLC data, and then are decoded in detail by the MB parameter decode unit 30.

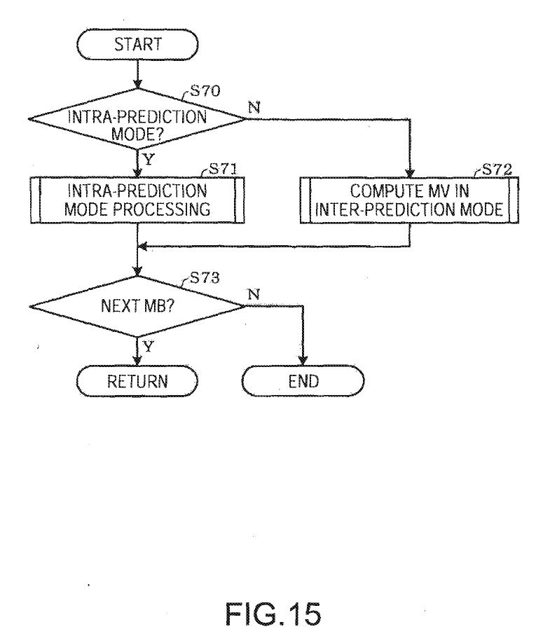

FIG. 15 is a flow chart of an example of processing of the MB parameter decode unit 30.

The MB parameter decode unit 30 has a CPU and a memory, which are not shown, and the CPU executes a program stored in the memory, implementing processing shown in FIG. 15.

First, the MB parameter decode unit 30 determines whether or not the mode of MB is intra prediction mode (step S70), and if the mode is intra prediction mode (step S70: Y), then intra prediction mode process is performed (step S71).

If the mode is inter prediction mode (step S70: N), then the MB parameter decode unit 30 computes motion vectors MV in inter prediction mode (step, S 72).

Next to steps S71 and S72, if there is the next MB (step S73: Y), the process returns to step S70 (Return).

If there is not the next MB (step S73: N), the process ends (End).

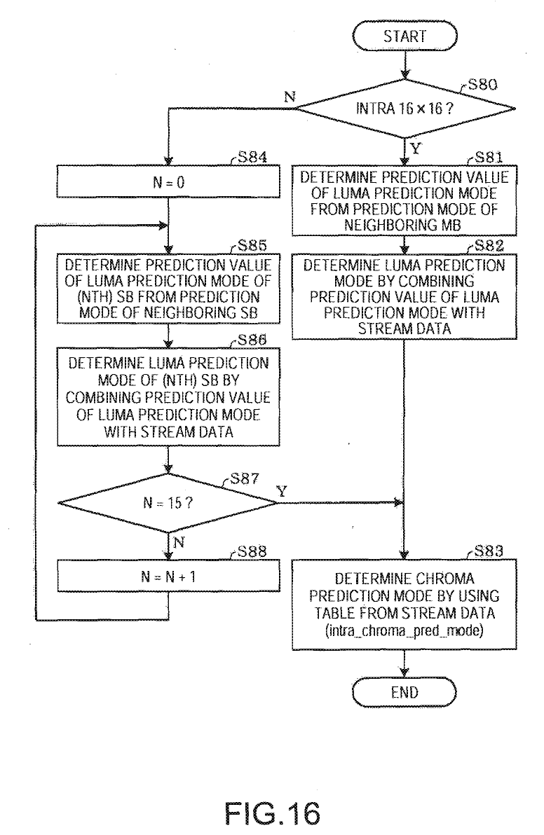

FIG. 16 is a flow chart of an example of processing of intra prediction mode process performed in step S71 in FIG. 15.

First, the MB parameter decode unit 30 determines whether or not the mode of the target MB is intra 16×16 mode (step S80), and if the mode is intra 16×16 mode (step S80: Y), then the prediction value in a luma prediction mode is determined from the prediction mode of the neighboring MB (step S81).

Next, the luma prediction mode is determined by combining the prediction value of the luma prediction mode with stream data (step S82).

Then, the choma prediction mode is determined from intra_choroma_pred_mode of stream data by using a table (step S83), and thus the process ends (END).

If it is determined that the mode is not intra 16×16 mode (step S80: N), then a variable N is initialized to 0 (step S84), and the prediction value of the luma prediction mode of the Nth SB is determined from the prediction mode of the neighboring sub macroblock (SB) (step S85).

Next, the luma prediction mode of the Nth SB is determined by combining the prediction value of the luma prediction mode with the stream data (step S86).

If N is 15 (step S87: Y), then the process proceeds to step S83.

If N is not 15 (step S87: N), then N is incremented (step S88) and the process proceeds to the step for the next SB.

As described above, the MB parameter decode unit 30 determines parameter data required for intra prediction.

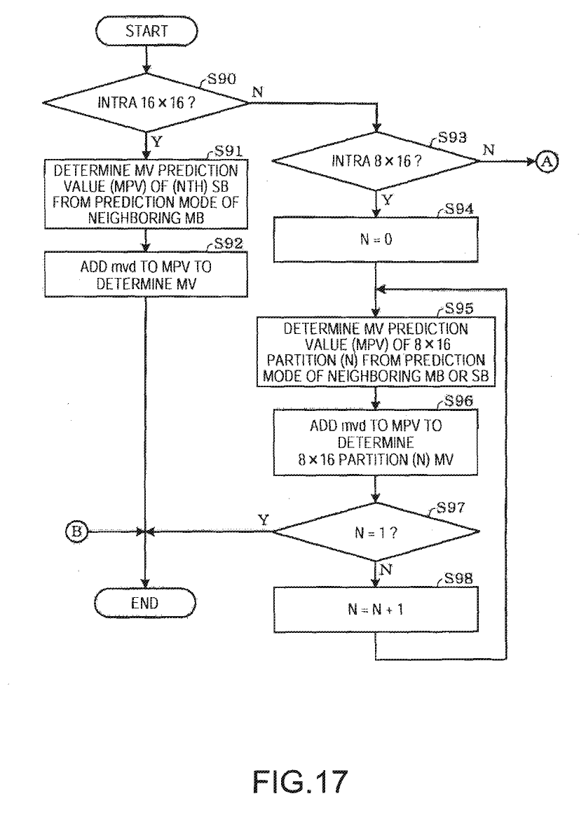

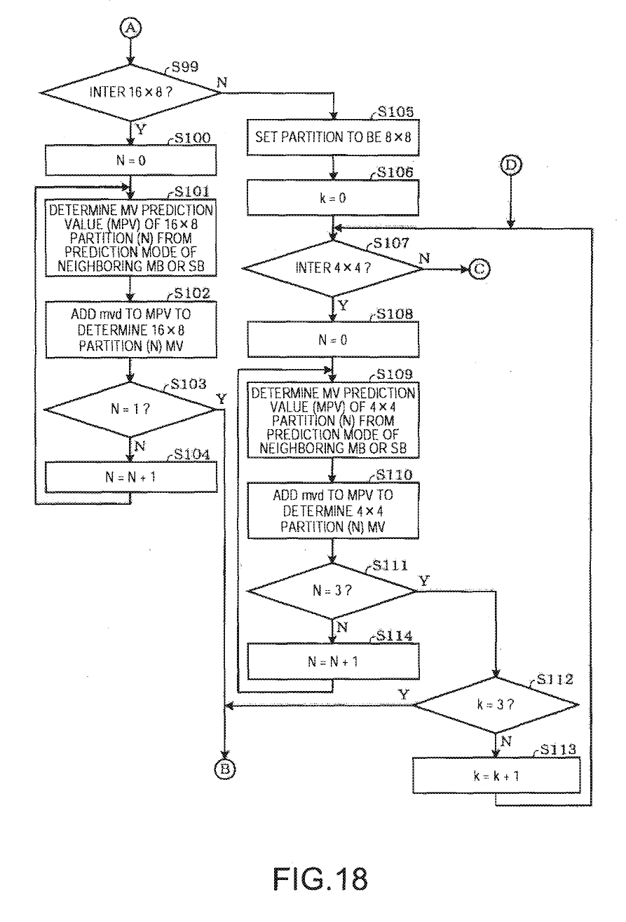

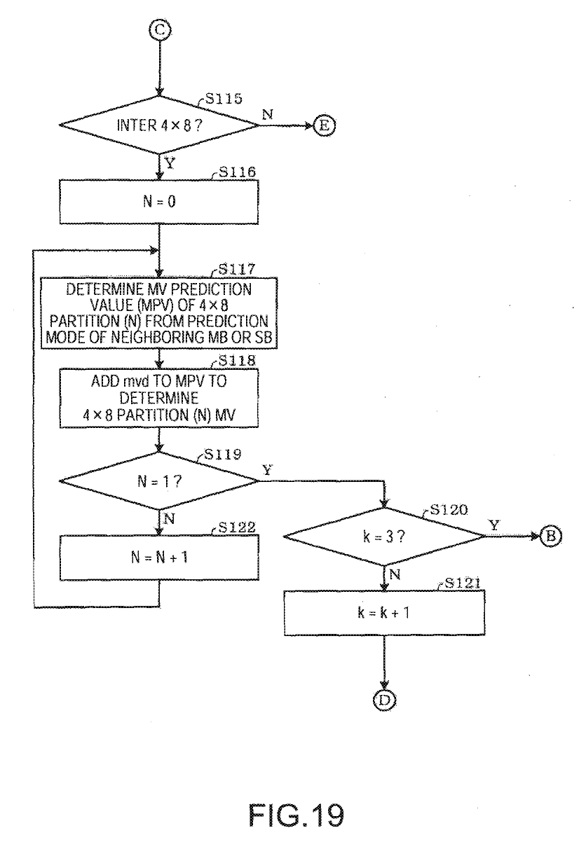

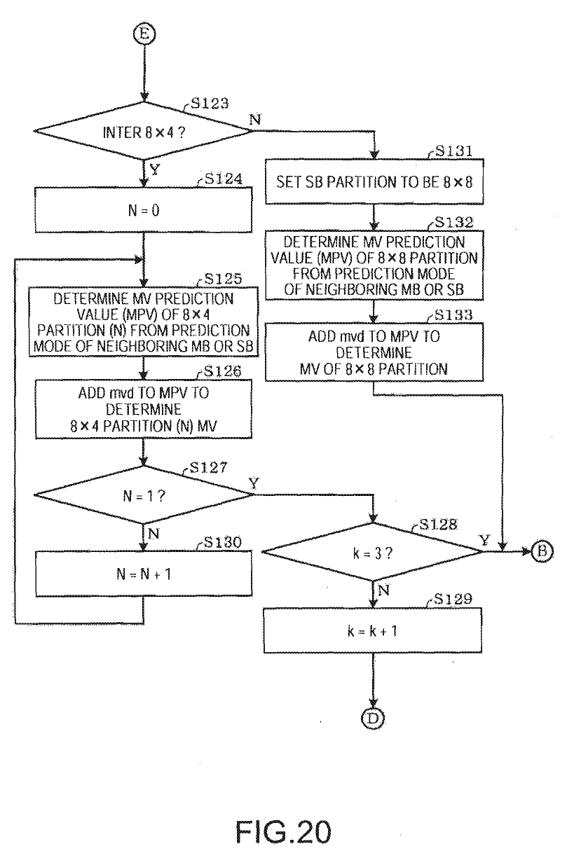

FIGS. 17 to 20 are a flow chart of an example of processing of motion vector computing process in inter prediction mode performed in step S72 in FIG. 15.

First, the MB parameter decode unit 30 determines whether or not the mode of the MB is inter 16×16 mode (step S90), and if the mode is inter 16×16 mode (step S90: Y), then a motion vector prediction value MPV of Nth SB is determined from the prediction, mode of the neighboring SB (step S91).

Next, motion vector information mvd is added to the motion vector prediction value MPV to determine motion vector MV (step S92).

The process ends (END).

If it is determined that the mode is not inter 16×16 mode in step S90 (step S90: N), then the MB parameter decode unit 30 determines whether or not the mode is inter 8×16 mode (step S93).

If the mode is inter 8×16 mode (step S93: Y), then the variable N is initialized to 0 (step S94) and the motion vector prediction value MPV of Nth 8×16 partition from prediction mode of the neighboring MB or SB is determined (step S95).

Next, motion vector information mvd is added to the motion vector prediction value MPV to determine a motion vector MV of Nth 8×16 partition (step S96).

If N is 1 (step S97: Y), the process ends(END), whereas if N is not 1 (step S97: N), N is incremented (step S98) and the process proceeds to the process for the next partition.

If it is determined that the mode is not inter 8×16 mode (step S93: N), then the MB parameter decode unit 30 determines whether or not the mode is inter 16×8 mode (step S99).

If the mode is inter 16×8 mode (step S99: Y), then the variable N is initialized to 0) (step S100) and the motion vector prediction value MPV of Nth 16×8 partition from the prediction mode of the neighboring MB or SB is determined (step S101).

Next, motion vector information mvd is added to the motion vector prediction value MPV to determine a motion vector MV of Nth 16×8 partition (step S102).

If N is 1 (step S103: Y), the process ends (END), whereas if N is not 1 (step S103: N), N is incremented (step S104) and the process proceeds to the process for the next partition.

If the mode is not inter 16×8 mode (step S99: N), the MB parameter decode unit 30 sets partition to be 8×8 (step S105).

A variable k is set to be 0 (step S106), the MB parameter decode unit 30 determines whether or not the mode is inter 4×4 mode (step S107).

If it is determined that the mode is inter 4×4 mode (step S107: Y), then the variable N is initialized to 0 (step S118) and the motion vector prediction value MPV of Nth 4×4 partition from prediction mode of the neighboring MB or SB is determined (step S109).

Next, motion vector information mvd is added to the motion vector prediction value MPV to determine a motion vector MV of Nth 4×4 partition (step S110).

If N is 3 (step S111: Y) and k is 3 (step S112: Y), the process ends (END), whereas if k is not 3 (step S112: N), k is incremented (step S113) and the process returns to step S107.

If N is not 3 (step S111: N), N is incremented (step S114) and the process proceeds to the process for the next partition.

If it is determined that the mode is not inter 4×4 mode (step S107: N), then the MB parameter decode unit 30 determines whether or not the mode is inter 4×8 mode (step S115).

If the mode is inter 4×8 mode (step S115: Y), then the variable N is initialized to 0 (step S116) and the motion vector prediction value MPV of Nth 4×8 partition from the prediction mode of the neighboring MB or SB is determined (step S117).

Next, motion vector information mvd is added to the motion vector prediction value MPV to determine a motion vector MV of Nth 4×8 partition (step S118).

If N is 1 (step S119: Y) and k is 3 (step S120: Y), the process ends (END), whereas if k is not 3 (step S120: N), k is incremented (step S121) and the process returns to step S107.

If N is not 1 (step S119: N), then N is incremented (step S122) and the process proceeds to the process for the next partition.

If it is determined that the mode is not inter 4×8 mode (step S115: N), then the MB parameter decode unit 30 determines whether or not the mode is inter 8×4 mode (step S123).

If the mode is inter 8×4 mode (step S123: Y), then the variable N is initialized to 0 (step S124) and the motion vector prediction value MPV of Nth 8×4 partition from prediction mode of the neighboring MB or SB is determined (step S125).

Next, motion vector information mvd is added to the motion vector prediction value MPV to determine a motion vector MV of Nth 8×4 partition (step S126).

If N is 1 (step S127: Y) and k is 3 (step S128: Y), the process ends (END), whereas if k is not 3 (step S128: N), k is incremented (step S129) and the process returns to step S107.

If N is not 1 (step S127: N), then N is incremented (step S130) and the process proceeds to the process for the next partition.

If it is determined that the mode is not inter 8×4 mode (step S123: N), then MB parameter decode unit 30 sets partition of SB to be 8×8 (step S131) to determine the motion vector prediction value MPV of 8×8 partition from the prediction mode of the neighboring MB or SB (step S132).

Next, motion vector information mvd is added to the motion vector prediction value MPV to determine a motion vector MV of 8×8 partition (step S133).

Then, the process ends (END).

As described above, the MB parameter decode unit 30 determines parameter data required for inter prediction.

### 1.4 Modification

A decoding device in the embodiment is not limited to the configuration shown in FIG. 1, and the same effects as in the embodiment can be obtained by a decoding device in a modification of the embodiment as described below.

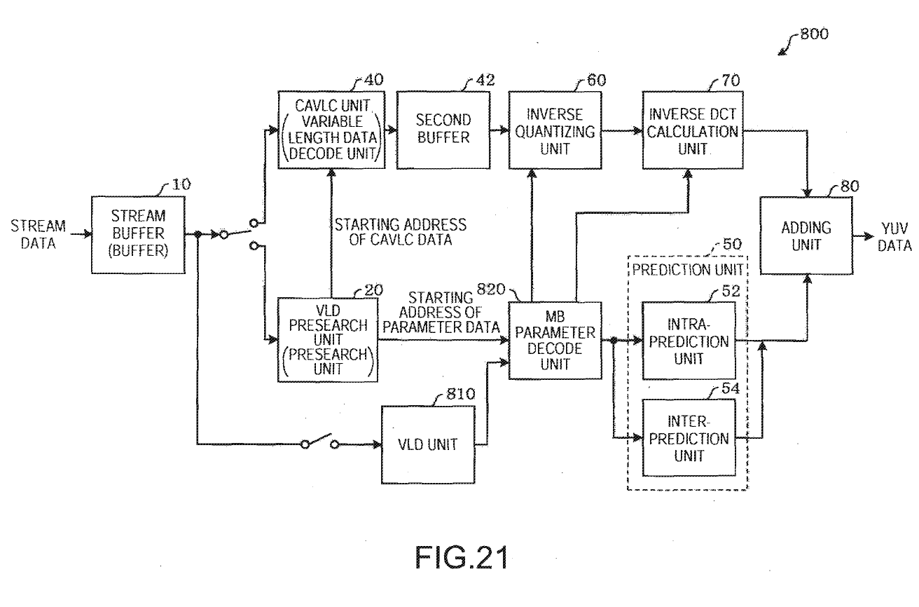

FIG. 21 is a block diagram of main portions of the configuration of a decoding device in a modification of the embodiment.

Note that such components as are found in FIG. 1 are indicated by the same reference numerals and the common explanation is suitably omitted.

The decoding device in the present modification can also be applied to the decoding device 500 shown in FIG. 6.

A decoding device 800 of the modification differs from the decoding device 100 of the embodiment in omitting the first buffer 22.

That is, the VLD presearch unit 20 notifies an MB parameter decode unit 820 in the modification of the starting address of the stream buffer 10 in which parameter data are stored.

Then, the MB parameter decode unit 820 decodes parameter data, which are included in the data for which Golomb decoding and the like have been performed in the processing through a VLD unit 810 from the stream buffer 10.

By this way, the CAVLC unit 40 and the MBs parameter decode unit 820 can be operated in parallel, while the first buffer 22 is omitted.

### 1.5 Hardware Configuration Example

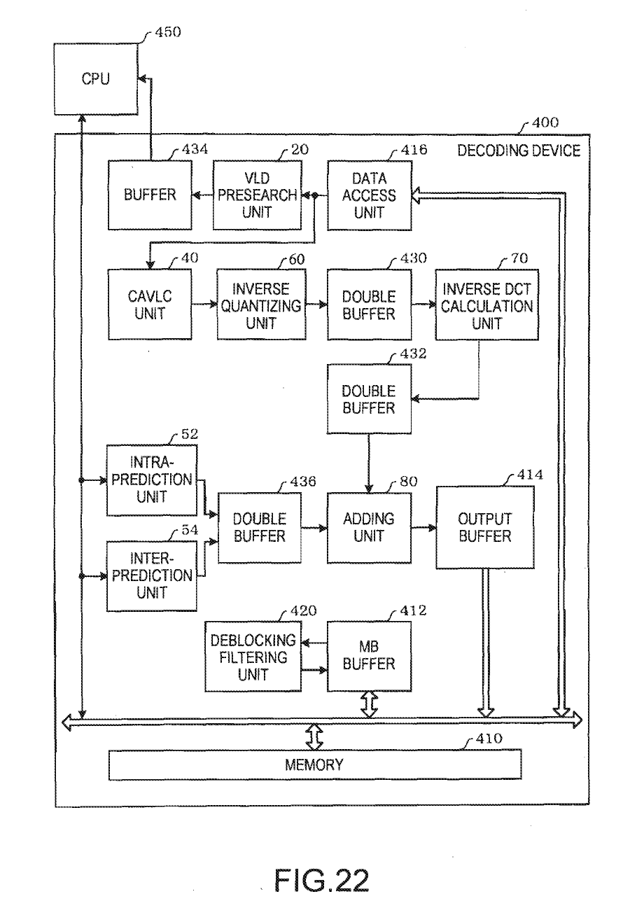

FIG. 22 is a block diagram of a hardware configuration example of the decoding device 100 in the embodiment.

In FIG. 22, such components as are found in FIG. 1 or FIG. 5 are indicated by the same reference numerals and the common explanation is suitably omitted.

The decoding device 400 has a memory 410, to which an MB buffer 412, an output buffer 414 and a data access unit (the data access circuit in FIG. 13) 416 are coupled through a common bus.

The MB buffer 412 is coupled to a deblocking filtering unit 420.

The inverse quantizing unit 60 is coupled through a double buffer 430 to the inverse DCT calculation unit 70.

The inverse DCT calculation unit 70 is coupled through the double buffer 432 to the adding unit 80.

Coupled to the decoding device 400 is a CPU 450 disposed outside the decoding device 400, and the CPU 450 implements the function of the MB parameter decode unit 30.

The CPU 450 can access the intra-prediction unit 52 and the inter-prediction unit 54.

The CPU 450 can access the memory 410, the MB buffer 412, the output buffer 414 and the data access unit 416 through the buses.

Further, a double buffer 436 is disposed between the adding unit 80 and either of the intra-prediction unit 52 and the inter-prediction unit 54.

The output result of the VLD presearch unit 20 is buffered into a buffer 434, and then is supplied to the CPU 450.

Such double buffers 430 and 432, and buffer 434 enable implementation of pipeline operations in the former part and the latter part of the buffers.

2. Information Reproducing Apparatus

Next, an information reproducing apparatus to which a decoding device in the embodiment is applied will be described.

An information reproducing apparatus in the embodiment enables programs from digital terrestrial broadcasting to be reproduced and picture data encoded according to H.264/AVC standard to be decoded.

2.1 Overview of One-Segment Broadcasting

Digital terrestrial broadcasting, which makes an appearance in place of analogue terrestrial broadcasting, is expected to provide various new services in addition to high quality images and sound.

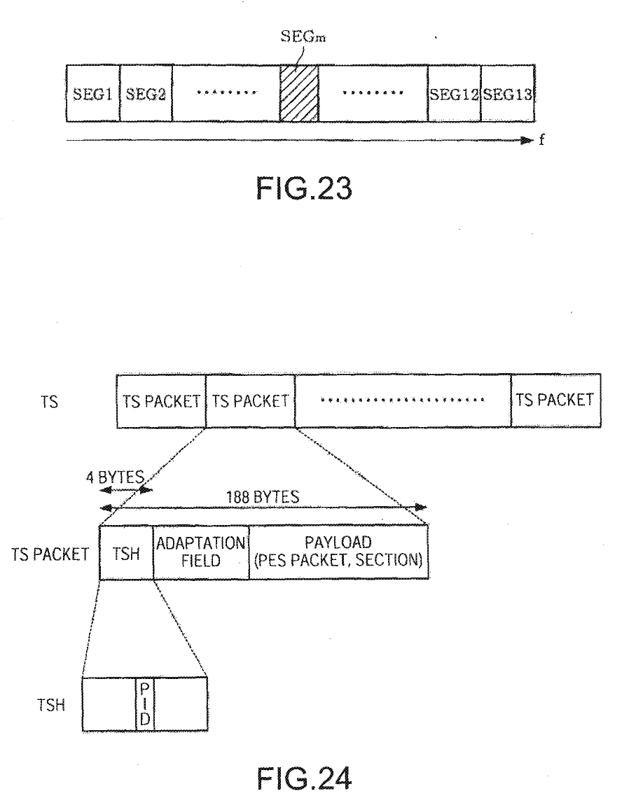

FIG. 23 is an explanatory view of the concept of segments of digital terrestrial broadcasting.

In digital terrestrial broadcasting, the frequency band assigned in advance is divided into 14 segments, and a program is broadcast using 13 segments SEG1 to SEG 13 of the 14 segments.

The remaining one segment is used as a guard band.

One segment SEG among 13 segments for broadcast is assigned to the frequency band of broadcasting for portable terminals.

In one segment broadcasting, a transport stream (TS) is transmitted in which picture data, sound data and other data (control data), each being encoded (compressed), are multiplexed.

More specifically, after a Read-Solomon error-correcting code is added to each packet of a TS, the TS is divided into layers, and convolutional coding and carrier modulation are applied to each layer.

After layer composition, frequency interleaving and time interleaving are performed, and pilot signals needed for the receiver are added, forming orthogonal frequency division multiplexing (OFDM) segment frame.

Inverse Fourier transform calculation is applied to the OFDM segment frame, and the frame is transmitted as OFDM signals.

FIG. 24 is an explanatory view of a TS.

A TS is composed of a plurality of TS packets as shown in FIG. 24.

The length of each TS packet is fixed to 188 bytes.

Four byte header information called TS header (TSH), which includes a packet identifier (PID) functioning as an identifier of a TS packet, is added to each TS packet.

Programs of one segment broadcasting is specified by a PID.

A TS packet includes an adaptation field in which a program clock reference (PCR), which is time information functioning as the reference for synchronous reproduction of picture data, sound data and the other data, and dummy data are embedded.

A payload includes data for generating a PES packet and a section.

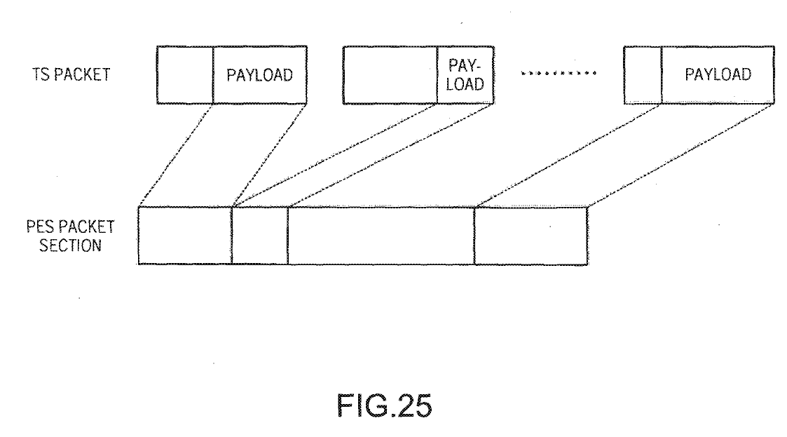

FIG. 25 is an explanatory view of the PES packet and the section.

Each of PES packets and sections is made of a payload of each of one or more TS packets.

The PES packet includes a PES header and a payload.

Picture data, sound data or caption data are set as elementary stream (ES) data in the payload.

Program information of image data or the like set in the PES packet is set in the section.

Therefore, when a TS has been received, it is necessary to first analyze program information included in the section to identify a PID corresponding to a program to be broadcast.

Then, the image data and sound data corresponding to the PID are extracted from the TS, and the extracted image data and sound data are reproduced.

2.2 Portable Terminal

Processing such as packet analysis as described above is needed in portable terminals having functions of receiving one segment broadcasting.

That is, high performance is required for such portable terminals.

Therefore, in the case of adding functions of receiving one segment broadcasting to conventional cellular phones as portable terminals (electronic apparatus in the broad sense), processors having high performance need to be further added.

FIG. 26 is a block diagram of a configuration example of a cellular phone including a multimedia CPU in the comparative example of the embodiment.

In this cellular phone 900, a receiving signal received through an antenna 910 is demodulated and a telephone CPU 920 performs incoming calling, and the telephone CPU 920 performs calling and a signal is modulated and transmitted through the antenna 910.

The telephone CPU 920 can perform incoming calling and calling by, reading a program stored in a memory 922.

When a desired signal is extracted through a tuner 940 from a receiving signal that has been received through the antenna 930, a TS is generated by using the desired signal as an OFDM signal in the inverse order to that of the above procedures.

A multimedia CPU 950 analyzes a TS packet from the generated TS to determine a PES packet and a section, and decodes picture data and sound data from the TS packet of a desired program.

The multimedia CPU 950 can perform the above-mentioned packet analysis and decoding by reading a program stored in a memory 952.

A display panel 960 performs display based on decoded picture data.

A speaker 970 outputs sound based on the decoded sound data.

Thus, the multimedia CPU 950 needs to have very high performance.

Processors with high performance generally have high operation frequencies and large circuit sizes.

Considering the bit rate of one segment broadcasting, most of the band is used as that of picture data and sound data and therefore the band of data broadcasting is narrows.

As a result, although, among processing that can be performed by multimedia CPU, some processing can be performed only by reproducing picture data and sound data, the multimedia CPU needs to be always operated.

This leads to an increase of power consumption.

In the embodiment, a picture decoder to decode picture data and a sound decoder to decode sound data are separately provided, and each perform decoding independently.

This makes it possible to employ decoders each having low performance.

Further, this allows flexible reduction of power consumption by optionally stopping the operation of either the picture decoder or the sound decoder.

Further, since the picture decoder and the sound decoder can be operated in parallel, lower performance is needed for each decoder.

As a result, lower power consumption and lower cost can further be achieved.

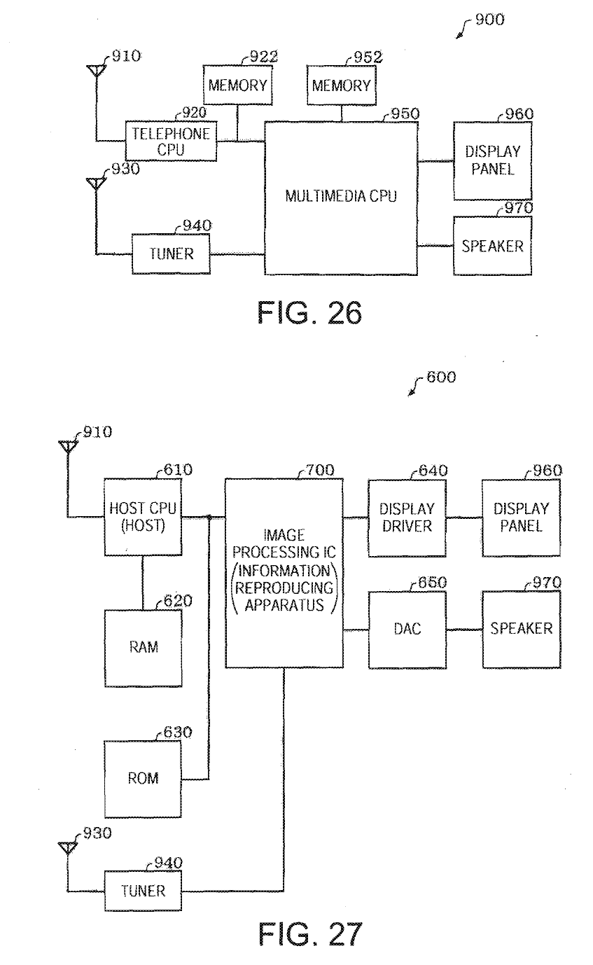

FIG. 27 is a block diagram of a configuration example of a cellular phone including an information reproducing apparatus in the embodiment.

Note that, in FIG. 27, such components as are found in FIG. 26 are indicated by the same reference numerals and the common explanation is suitably omitted.

A cellular phone (electronic apparatus in the broad sense) 600 may include a host CPU (host in the broad sense) 610, a random access memory (RAM) 620, a read only memory (ROME) 630, a display driver 640, a digital-to-analog converter (DAC) 650, and an image information IC (information reproducing apparatus in the broad sense) 700.

The cellular phone 600 further includes the antennas 910 and 930, the tuner 940, the display panel 960 and the speaker 970.

The host CPU 610 has a function to control the image information IC 700 as well as functions of the telephone CPU 920 in FIG. 26.

The host CPU 610 reads a program stored in the RAM 620 or the ROM 630 and performs processes of the telephone CPU 920 in FIG. 26 and a process to control the image information IC 700.

At this point, the host CPU 610 can use the RAM 620 as a work area.

In the image information IC 700, a picture TS packet for generating picture data (first TS packet) and a sound TS packet for generating sound data (second TS packet) are extracted from a TS from the tuner 940, and those data are buffered into a shared memory, which is not shown.

The image information IC 700 includes a picture decoder and a sound decoder (not shown) that can mutually independently control stopping the operation.

The picture decoder and the sound decoder decode a picture TS packet and a sound TS packet to generate picture data and sound data, respectively.

The picture data and the sound data are supplied to the display driver 640 and the DAC 650, respectively, while synchronizing each other.

The host CPU 610 can instruct the image information IC 700 as mentioned above to start picture decoding and sound decoding.

Additionally, the host CPU 610 may instruct the image information IC 700 to start at least one of picture decoding and sound decoding.

The display driver (the drive circuit in the broad sense) 640 drives the display panel (electro-optical device in the broad sense) 960.

More specifically, the display panel has a plurality of scan lines, a plurality of data lines, and a plurality of pixels each specified by each scan line and each data line.

As the display panel, a liquid crystal display panel can be employed.

The display driver 640 has a scan driver function to scan a plurality of scan lines, and a data driver function to drive a plurality of data lines based on the picture data.

The DAC 650 converts sound data of digital signals to analogue signals, and supplies the analogue signals to the speaker 970.

The speaker 970 outputs sound corresponding to the analogue signals from the DAC 660.

2.3 Information Reproducing Apparatus

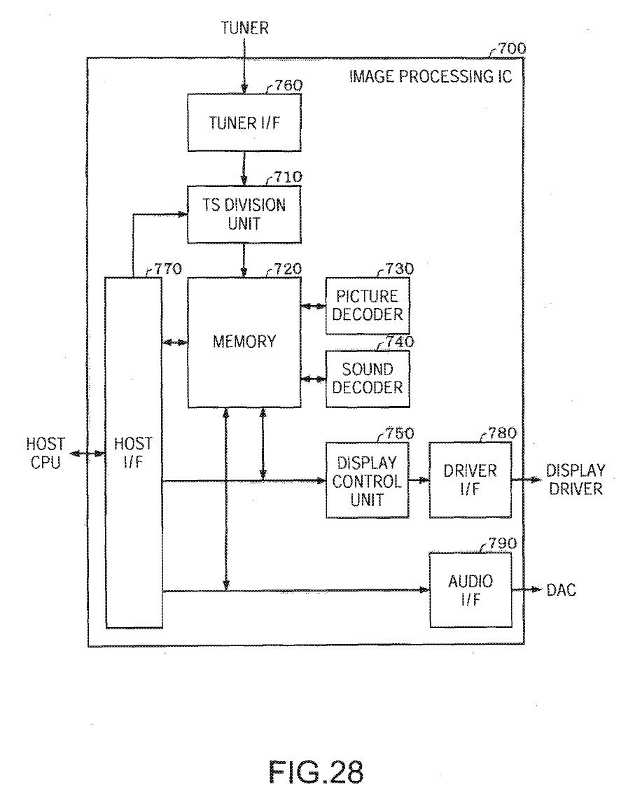

FIG. 28 is a block diagram of a configuration example of the image information IC 700 in FIG. 27 as an information reproducing apparatus of the embodiment.

The image information IC 700 includes a TS division unit (a division processing unit) 710, a memory (a shared memory) 720, a picture decoder 730 and a sound decoder 740.

The image information IC 700 further includes a display control unit 750, a tuner interface (I/F) 760, a host I/F 770, a driver I/F 780 and an audio I/F 790.

Here, the picture decoder 730 include a CPU, which is not shown, and the function of the picture decoder 730 is implemented by the decoding device 500 in the embodiment.

The TS division unit 710 extracts from a TS a picture TS packet (first TS packet) for generating picture data, a sound TS packet (second TS packet) for generating sound data, and a packet (third TS packet) other than the picture TS packet and the sound TS packet.

The TS division unit 710 can extract the first and second TS packets from the TS based on the analysis result of the host CPU 610 that analyzes the third TS packet once extracted.

The memory 720 has a plurality of memory areas.

Each memory area has its predetermined starting and ending addresses.

The picture TS packet, the sound TS packet and the other TS packet divided by the TS division unit 710 are stored in respective memory areas for exclusive use.

The picture decoder 730 reads a picture TS packet from a memory area that is one among memory areas in the memory 720 and that is provided exclusively for the picture TS packet, and performs picture decoding for generating picture data based on the picture TS packet.

The sound decoder 740 reads a sound TS packet from a memory area that is one among memory areas in the memory 720 and that is provided exclusively for the sound TS packet, and performs sound decoding for generating sound data based on the sound TS packet.

The display control unit 750 performs rotating to rotate an image represented by picture data read from the memory 720 and resizing to contract or expand the size of the image.

Data after rotation and data after resizing are supplied to the driver I/F 780.

The tuner I/F 760 performs interfacing with the tuner 940.

More specifically, the tuner I/F 760 controls receiving a TS from the tuner 940.

The tuner I/F 760 is coupled to the TS division unit 710.

The host I/F 770 performs interfacing with the host CPU 610.

More specifically; the host I/F 770 controls transmitting and receiving data with the host CPU 610.

The host I/F 770 is coupled to the TS division unit 710, the memory 720, the display control unit 750 and the audio I/F 790.

The driver I/F 780 reads picture data at a predetermined cycle from the memory 720 through the display control unit 750, and supplies the picture data to the display driver 640.

The driver I/F 780 performs interfacing with the display driver 640 so as to transmit the picture data.

The audio I/F 790 reads sound data at a predetermined cycle from the memory 720, and supplies the sound data to the DAC 650.

The audio I/F 790 performs interfacing with the DAC 650 so as to transmit the sound data.

In FIG. 28, the picture decoder 730 implements the function of the decoding device 500 in FIG. 5.

In FIG. 28, the memory 720 implements the function of the stream buffer in FIG. 1.

In the image information IC 700 configured in this way, TS packets are extracted from a TS from the tuner 940 by the TS division unit 710.

The TS packets are stored in preassigned memory areas of the memory 720 functioning as a shared memory.

The picture decoder 730 and the sound decoder 740 each read a TS packet from the memory area assigned exclusively for the TS packet in the memory 720.

Therefore, the picture decoder 730 and the sound decoder 740 can generate picture data and sound data, and supply the picture data and the sound data in synchronization with each other to the display driver 640 and the DAC 650, respectively.

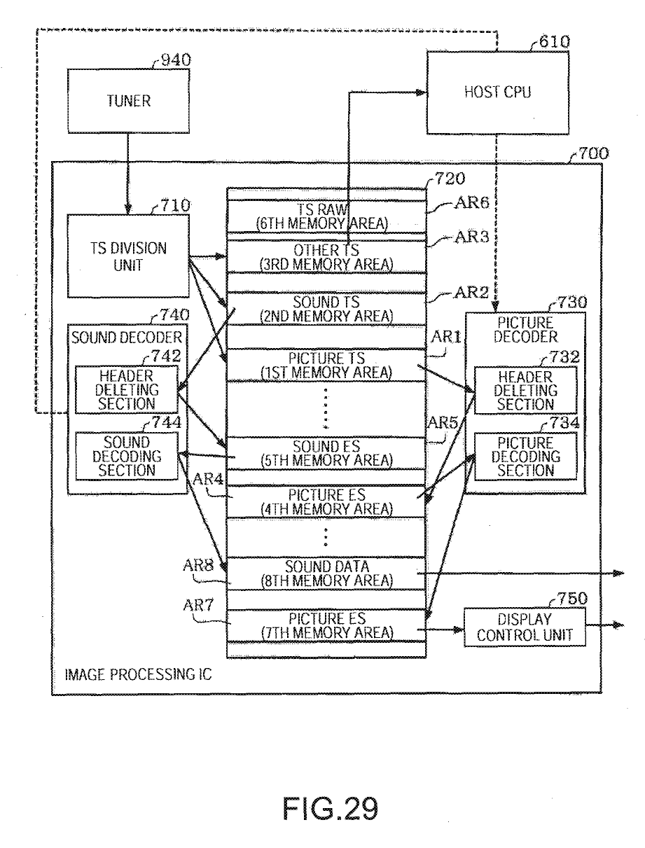

FIG. 29 is an explanatory view of operations of the image information IC 700 of FIG. 28.

In FIG. 29, such components as are found in FIG. 28 are indicated by the same reference numerals and the common explanation is suitably omitted.

The memory 720 has first to eighth memory areas AR1 to AR8, which are preassigned.

Stored in the first memory area AR1, as an exclusive memory area for a picture TS packet, is a picture TS packet (first TS packet) extracted by the TS division unit 710.

Stored in the second memory area AR2, as an exclusive memory area for a sound TS packet, is a sound TS packet (second TS packet) extracted by the TS division unit 710.

Stored in the third memory area AR5 is a TS packet (third TS packet) other than the picture TS packet and the sound TS packet among TS packets extracted by the TS division unit 710.

Stored in the fourth memory area AR4, as an exclusive memory area for picture ES data, are picture ES data generated by the picture decoder 730.

Stored in the fifth memory area AR5, as an exclusive memory area for sound ES data, are sound ES data generated by the sound decoder 740.

Stored in the sixth memory area AR6 is a TS generated by the host CPU 610 as TS RAW data.

The TS RAW data are set instead of a TS from the tuner 940 by the host CPU 610.

The TS division unit 710 extracts a picture TS packet, a sound TS packet and the other TS packet from the TS set as TS RAW data.

Stored in the seventh memory area AR7 are picture data that have been decoded by the picture decoder 730.

The picture data stored in the seventh memory area AR7 are read by the display control unit 750, and are used for outputting a picture by the display panel.

Stored in the eighth memory area AR8 are sound data that have been decoded by the sound decoder 740.

The sound data stored in the eighth memory area, AR8 are used for outputting sound by the speaker 970.

The picture decoder 730 includes a header deleting section 732 and a picture decoding section 734.

The header deleting section 732 reads a picture TS packet from the first memory area AR1.

After analyzing the TS header of the picture TS packet and generating a PES packet (first PES packet), the header deleting section 732 deletes the PES header and stores the payload of the PES packet as picture ES data in the fourth memory area AR4 of the memory 720.

The picture decoding section 734 reads picture BS data from the fourth memory area AR4, decodes the picture ES data according to H.264/AVC standard (picture decoding in the broad sense) to generate picture data, and write the generated picture data to the seventh memory area AR7.

The picture decoding section 734 implements the function of decoding device 100 in FIG. 1 or the decoding device 800 in FIG. 21.

The sound decoder 740 includes a header deleting section 742 and a picture decoding section 744.

The header deleting section 742 reads a sound TS packet from the second memory area AR2.

After analyzing the TS header of the sound TS packet and generating a PES packet (second PES packet), the header deleting section 742 deletes the PES header and stores the payload of the PES packet as sound ES data in the fifth memory area AR5 of the memory 720.

The sound decoding section 744 reads sound ES data from the fifth memory area AR5, decodes the sound ES data according to MPEG-2 advanced audio coding (AAC) standard (sound decoding in the broad sense) to generate sound data, and write the generated sound data to the eighth memory area AR8.

The picture decoder 730 reads a picture TS packet (first TS packet), independently of the sound decoder 740, from the first memory area AR1, and performs picture decoding as described above based on the picture TS packet.

The sound decoder 740 reads a sound TS packet (second TS packet), independently of the picture decoder 730, from the second memory area AR2, and performs sound decoding as described above based on the sound TS packet.

By this way, the picture decoder 730 and the sound decoder 740 can operate when outputting a picture and sound in synchronization, and also the picture decoder 730 alone can operate while the sound decoder 740 stops the operation when outputting only a picture.

By this way, the sound decoder 740 alone can operate while the picture decoder 730 stops the operation when outputting only sound.

The host CPU 610 reads the other TS packet (third TS packet) stored in the third memory area AR3 and generates a section from the TS packet.

Various table information included in the section is analyzed.

The host CPU 610 sets the analysis result in a predetermined memory area of the memory 720 and also designates the analysis result as control information in the TS division unit 710.

Subsequent to this, the TS division unit 710 extracts a TS from a TS packet according to control information from the tuner 940.

On the other hand, the host CPU 610 can separately issue start commands to the picture decoder 730 and the sound decoder 740.

The picture decoder 730 and the sound decoder 740 independently access the memory 720, read the analysis results of the host CPU 610, and perform decoding in correspondence to the analysis results.

2.3.1 Reproducing Operation

Next, description will be given below on operations of the image information IC 700 as the information reproducing apparatus in the embodiment when reproducing picture data or sound data multiplexed in a TS.

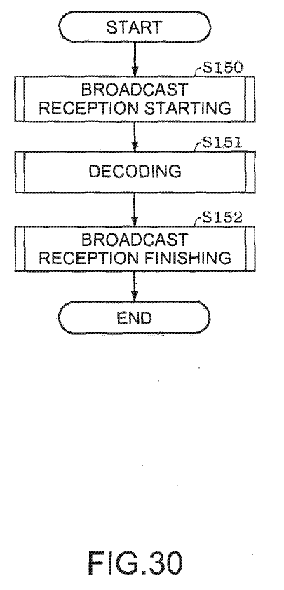

FIG. 30 is a flow chart of an operation example of reproducing of the host CPU 610.

The host CPU 610 reads a program stored in the RUM 620 or the ROM 630 and executes processing corresponding to the program.

Thus, processing shown in FIG. 30 can be performed.

First, the host CPU 610 performs broadcast reception starting (step S150).

As a result, picture data or sound data of a desired program among a plurality of programs received as a TS can be extracted from the TS.

The host CPU 610 activates at least one of the picture decoder 730 and the sound decoder 740 of the image information IC 700.

Subsequently, the host CPU 610 causes the picture decoder 730 and the sound decoder 740 to perform decoding when reproducing a picture and sound.

The host CPU 610 stops the operation of the sound decoder 740 and causes the picture decoder 730 to perform decoding when reproducing only a picture.

The host CPU 610 also stops the operation of the picture decoder 730 and causes the sound decoder 740 to perform decoding when reproducing sound only (step S151).

Next, the host CPU 610 performs broadcast reception finishing (step S152), and the process ends.

Thus, the host CPU 610 stops the operations of units and sections of the image information IC 700.

2.3.1.1 Broadcast Reception Starting

A processing example of broadcasting reception starting shown in FIG. 30 will be described.

Here, description will be given on the case of reproducing a picture and sound.

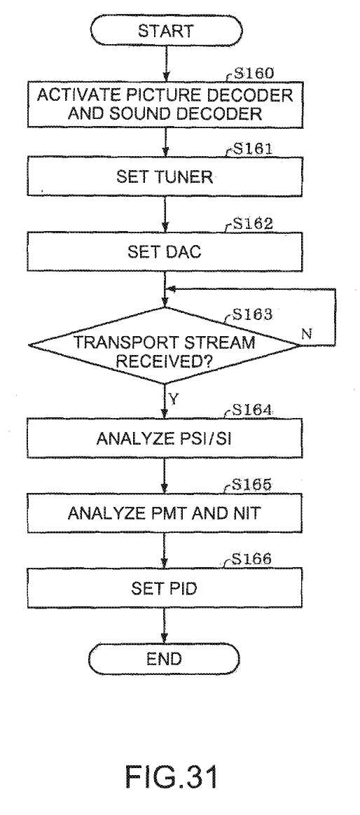

FIG. 31 is a flow chart of an operation example of broadcasting reception starting of FIG. 30.

The host CPU 610 reads a program stored in the RAM 620 or the ROM 630 and performs processing corresponding to the program.

Thus, processing shown in FIG. 31 can be performed.

The host CPU 610 first activates the picture decoder 730 and the sound decoder 740 of the image information IC 700 (step S160).

The host CPU 610 then initializes the tuner 940 and sets given operation information (step S161).

The host CPU 610 also initializes the DAC 650 and sets given operation information (step S162).

Then, the host CPU 610 monitors reception of a TS (step S163: N).

When the reception of the TS starts, in the image information IC 700, the TS division unit 710 divides the TS into a picture TS packet, a sound TS packet and the other TS packet as described above, and the divided TS packets are stored in the memory areas exclusively provided, respectively, in the memory 720.

For example, the host CPU 610 can detect reception of the TS by an interrupt signal under the condition where a TS packet is stored in the third memory area AR3 in the memory 720 of the image information IC 700.

Alternatively, the host CPU 610 periodically accesses the third memory area AR3 of the memory 720, and can determine reception of a TS by determining whether or not a TS packet is written.

If reception of a TS is detected in this way (step S163: Y), the host CPU 610 reads a TS packet stored in the third memory area AR3, and generates a section.

The host CPU 610 then analyzes program specific information (PSI) and service information (SI) included in the section (step S164).

The PSI/SI is prescribed by the MPEG-2 systems (ISO/IEC 13818-1).

The PSI/P includes a network information table (NIT) and a program map table (PMT).

The NIT includes a network identifier for specifying the broadcast station from which a TS is transmitted, a service identifier for specifying a PMT, a service identifier indicating the type of broadcasting, and the like.

A PID of a picture TS packet and a PID of a sound TS packet multiplexed in a TS are set in a PMT.

The host CPU 610 therefore extracts a service identifier for specifying a PMT from PSI/SI, and can specify the PID of the picture TS packet and the sound TS packet of the received TS based on the service identifier (step S165).

The host CPU 610 sets a PID corresponding to a program selected by a user of a portable terminal or a PID corresponding to a preset program in predetermined memory areas (e.g. third memory area AR39 of the memory 720) to allow the picture decoder 730 and the sound decoder 740 to refer to the PID (step S166).

Thus, the process ends (END).

By this way, the picture decoder 730 and the sound decoder 740 can decode a picture TS packet and a sound TS packet while referring a PID set in the memory 720.

Additionally, the host CPU 610 may set information corresponding to a service identifier for specifying a PMT in the TS division unit 710 of the image information IC 700.

Thus, the TS division unit 710 determines a section periodically received at a predetermined time interval, analyzes the PMT corresponding to the above-mentioned service identifier, and extracts a picture TS packet, a sound TS packet and the other TS packet specified by the PMT and stored the extracted packets in the memory 720.

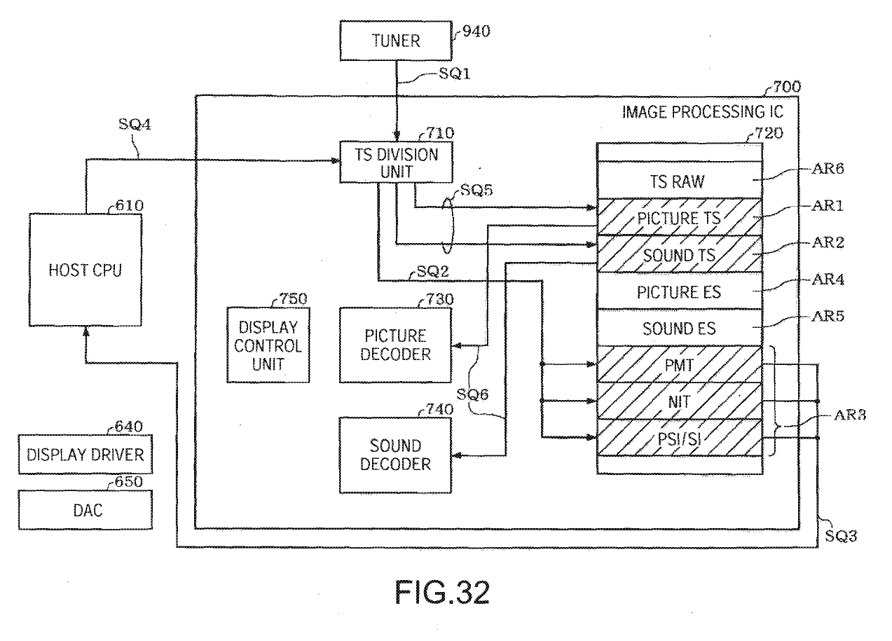

FIG. 32 is an explanatory view of operations in broadcasting reception starting of the image information IC 700 of FIGS. 28 and 29.

In FIG. 32, such components as are found in FIGS. 27 to 29 are indicated by the same reference numerals and the common explanation is suitably omitted.

Note that in FIG. 32, the fourth memory area AR4 and the seventh memory area AR7 share the same area, and the fifth memory area AR5 and the eighth memory area AR8 share the same area.

The PSI/SI, NIT and PMT are stored in predetermined memory areas in the third memory area AR3.

When a TS is input from the tuner 940 (SQ1), the TS division unit 710 stores a TS packet including PSI/SI in the memory 720 (SQ2).

At this point, the TS division unit 710 may extract PST/SI itself of the TS packet and store the PSI/SI itself in the memory 720.

Further, the TS division unit 710 may extract an NIT from the PSI/SI and store the NIT in the memory 720.

The host CPU 610 reads the PSI/SI, NIT and PMT (SQ3) and analyzes them to specify a PID corresponding to a program to be decoded.

The host CPU 610 sets information corresponding to the service identifier or the PID corresponding to a program to be decoded in the TS division unit 710 (SQ4).

In addition, the host CPU 610 also sets the PID in a predetermined memory area of the memory 720 so that the picture decoder 730 and the sound decoder 740 refer to the PID in decoding.

The TS division unit 710 extracts a picture TS packet and a sound TS packet from a TS based on the set PID, and writes the extracted picture TS packet and sound TS packet to first and second memory areas AR1 and AR2, respectively (SQ5).

Then, the picture decoder 730 and the sound decoder 740 activated by the host CPU 610 sequentially read the picture TS packet and the sound TS packet from the first and second memory areas AR1 and AR2 (SQ6), and perform picture decoding and sound decoding, respectively.

2.3.1.2 Broadcast Reception Finishing

Next, an operation example of broadcast reception finishing shown in FIG. 30 will be described.

Here, description will be given on the case of reproducing a picture and sound.

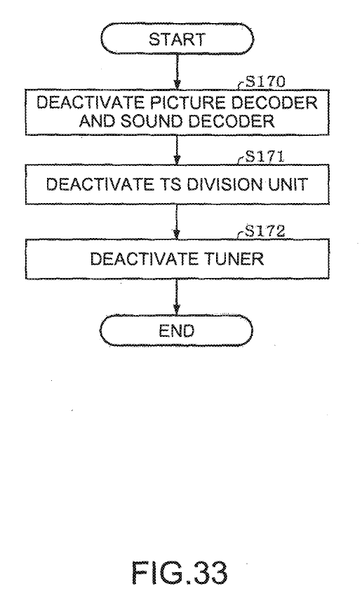

FIG. 33 is a flow chart of a processing example of the broadcast reception finishing of FIG. 30.

The host CPU 610 reads a program stored in the RAM 620 or the ROM 630 and performs processing corresponding to the program.

Thus, processing shown in FIG. 33 can be performed.

The host CPI 610 deactivates the picture decoder 730 and sound decoder 740 of the image information IC 700 (step S170).

For example, the host CPU 610 issues a control command to the image information IC 700, and the image information IC 700 deactivates the picture decoder 730 and the sound decoder 740 using the decode results of the control command.

Then, the host CPU 610 deactivates the TS division unit 710 in the same way (step S171).

The host CPU 610 deactivates the tuner 940 (step S172).

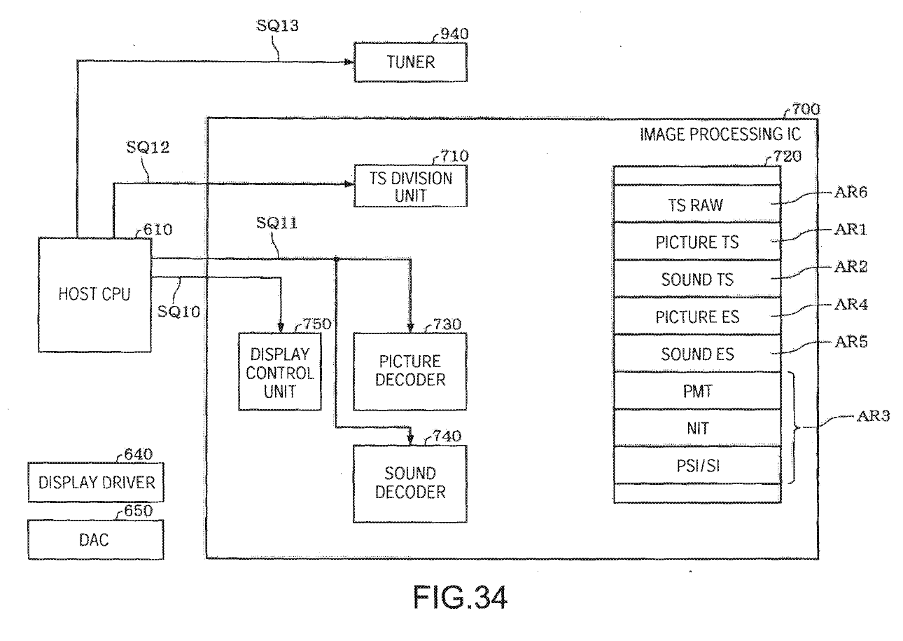

FIG. 34 is an explanatory view of operations in broadcasting reception finishing of the image information IC 700 of FIGS. 28 and 29.

In FIG. 34, such components as are found in FIG. 32 are indicated by the same reference numerals and the common explanation is suitably omitted.

The host CPU 610 controls the display control unit 750 so that the display control unit 750 stop the operation.

As a result, supplying picture data to the display driver 640 is stopped (SQ10).

Next, the operation of the picture decoder 730 and sound decoder 740 is stopped by the host CPU 610 (SQ11), and then the operation of the TS division unit 710 and the operation of the tuner 940 are stopped in this order (SQ12 and SQ13).

2.3.1.3 Reproducing

Next, an operation example of the picture decoder 730 that reproduces picture data will be described.

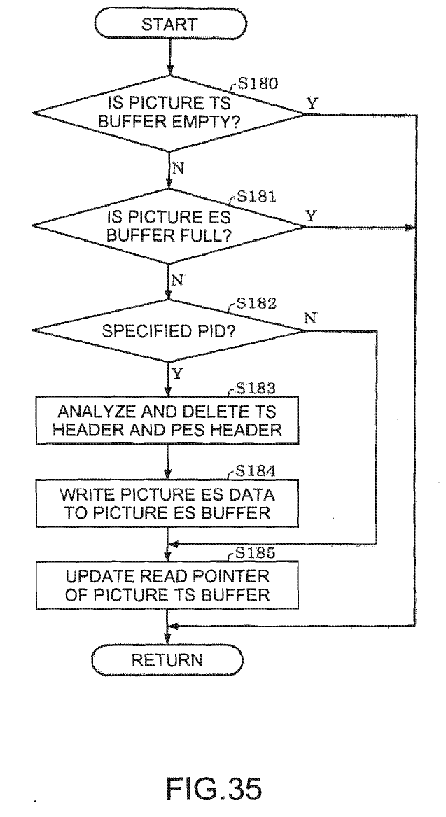

FIG. 35 is a flow chart of an operation example of the picture decoder 730.

When activated by the host CPU 610, the picture decoder 730 reads a program stored e.g., in a predetermined memory area of the memory 720 and executes processing in correspondence to the program, thereby performing the process shown in FIG. 35.

The picture decoder 730 determines whether or not the first memory area AR1 provided as a picture TS buffer is empty (step S180).

If the picture TS packet to be read from the first memory area AR1 is not present, the first memory area AR1 is empty.

If it is determined that the first memory area AR1, which is a picture TS buffer, is not empty (step S180: N), then the picture decoder 730 further determines whether or not the fourth memory area AR4 provided as a picture ES buffer is full (step S181).

If no more picture ES data can be stored in the fourth memory area AR4, the fourth memory area AR4 is full.

If it is determined that the fourth memory area AR4, which is a picture ES buffer, is not full (step S181: N), then the picture decoder 730 reads a picture TS packet from the first memory area AR1 and detects whether or not the PID of the picture TS packet is the PID specified by the host CPU 610 in step S166 in FIG. 31 (specified PID) (step S182).

If it is detected that the PID of the picture TS packet is the specified PID (step S182: Y), then the picture decoder 730 analyzes the TS header and the PES header (step S183) and stores picture ES data in the fourth memory area AR4, which is provided as a picture ES buffer (step S184).

Then, the picture decoder 730 updates the read pointer for specifying the read address of the first memory area AR1, which is a picture TS buffer (step S185), and the process returns to step S180 (REYURN).

In addition, if it is detected that the PID of the picture TS packet is not the specified PID (step S182: N), the process proceeds to step S185.

If it is determined that the first memory area AR1, which is a picture TS buffer, is empty (step S180: Y), or if it is determined that the fourth memory area AR4, which is a picture ES buffer, is full (step S181: Y), the process returns to step S180 (RETURN).

Thus, picture ES data stored in the fourth memory area AR4 are decoded according to H.264/ANC standard as described above by the picture decoder 730, and are written as picture data in the seventh memory area AR7 (see FIG. 29).

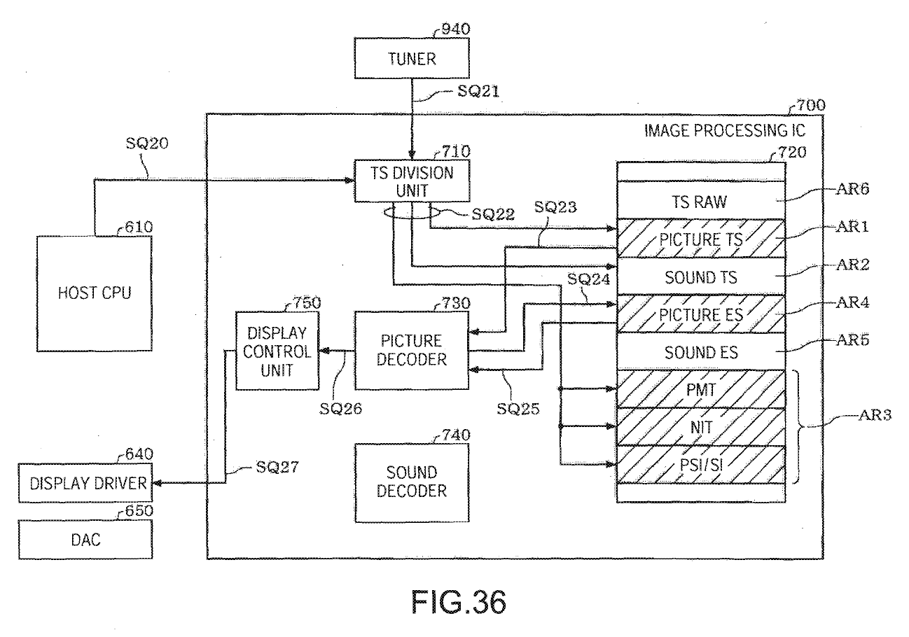

FIG. 36 is an explanatory view of operations of the picture decoder of the image information IC 700 of FIGS. 28 and 29.

Note that, in FIG. 36, such components as are found in FIG. 32 are indicated by the same reference numerals and the common explanation is suitably omitted.

Note that, in FIG. 36, the fourth memory area AR4 and the seventh memory area AR7 share the same area, and the fifth memory area AR5 and the eighth memory area AR8 share the same area.

The PSI/SI, the NIT and the PMT are stored in predetermined memory areas in the third memory area AR3.

A PID corresponding to a program to be decoded is set in the TS division unit 710 by the host CPU 610 as shown in FIG. 36 (SQ20).

When a TS is input from the tuner 940 (SQ21), the TS division unit 710 divides the TS from the tuner 940 into a picture TS packet, a sound TS packet and the other TS packet (SQ22).

The picture TS packet divided by the TS division unit 710 is stored in the first memory area AR1.

The sound TS packet divided by the TS division unit 710 is stored in the second memory area AR2.

The TS packet other than the picture TS packet and sound TS packet divided by the TS division unit 710 is stored in the third memory area AR3 as PSI/SI.

At this point, the TS division unit 710 extracts an NIT and a PMT in the PSI/SI, and stored the NIT and the PMT in the third memory area AR3.

Next, the picture decoder 730 activated by the host CPU 610 reads the picture TS packet from the first memory area AR1 (SQ23), generates picture ES data, and stores the picture ES data in the fourth memory area AR4 (SQ24).

Then, the picture decoder 730 reads picture ES data from the fourth memory area AR4 (SQ25), and decodes the read picture ES data according to H.264/AVC standard.

Here, as described above, parallel operations in the embodiment are performed.

Although decoded picture data are directly supplied to the display control unit 750 in FIG. 36 (SQ26), it is desirable that the decoded picture data be once written back to a predetermined memory area of the memory 720 and then be supplied, in synchronization with the output timing of sound data, to the display control unit 750.

Thus, the display driver 640 drives a display panel based on the picture data supplied to the display control unit 750 (SQ27).

In addition, the sound decoder 740, which reproduces sound data, similarly reads a sound TS packet from the second memory area AR2 provided as a sound TS buffer, analyzes the TS header and the PES header, and stores sound ES data in the fifth memory area AR5 provided as a sound ES buffer.

The sound ES data stored in the fifth memory area AR5 in this way are decoded according to MPEG-2AAC standard by the sound decoder 740, and are written as sound data to the eighth memory area AR8 (see FIG. 29).

The operations of the sound decoder 740 as described above are performed independently of those of the picture decoder 730.

The invention is not limited to the above-described embodiment, and various changes and modifications may be made without departing from the scope of the invention.

Examples that are applicable to digital terrestrial broadcasting have been described in the above embodiment and modification, but the invention is not limited to those that are applicable to digital terrestrial broadcasting.

Further, the decoding device in the embodiment that is applied to decoding in accordance with H.264/AVC standard has been described.

However, the decoding device is not limited to this.

It will be appreciated that the decoding device can be applied to decoding in accordance with other standards and the standards developed from H.264/AVC standard.

Further, in the aspects according to dependent claims of the invention, part of elements of the claims on which the dependent claims are dependent may be omitted.

The main portions of the aspect of the invention according to one independent claim of the invention may also be dependent on another independent claim.

What is claimed is:

1. A decoding device for decoding stream data including first data after first variable length encoding and second data after second variable length encoding in a stream form, the decoding device comprising:
a presearch unit that, based on parameter data for each macroblocks, analyzes a mode of a macroblock and performs first variable length decoding corresponding to the first variable length encoding to determine a starting address of a stream buffer in which the second data are stored;
a parameter decode unit that decodes the first parameter data, based on parameter data after the first variable length decoding, to determine a parameter value of the macroblock; and
a data decode unit that performs second variable length decoding of the second data corresponding to the second variable length encoding;
the data decode unit reads second data from the stream buffer based on the starting address from the presearch unit and performs the second variable length decoding of the second data.

2. The decoding device according to claim 1, wherein the parameter decode unit and the data decode unit operate in parallel after processing of the presearch unit.

3. The decoding device according to claim 1, wherein the parameter decode unit performs the first variable length decoding of data stored in the stream buffer and decodes the first data based on parameter data after the first variable length decoding.

4. The decoding device according to claim 1, further comprising:
an inverse quantizing unit that performs inverse quantization of data after the second variable length decoding;
an inverse discrete cosine transform calculation unit that performs inverse discrete cosine transform of data output from the inverse quantizing unit;
a prediction unit that performs one of inter-prediction and intra-prediction based on the parameter value; and
an adding unit that adds a result of the prediction unit and a result of the inverse discrete cosine transform calculation unit;
wherein the inverse quantizing unit, the inverse discrete cosine transform calculation unit, the prediction unit and the adding unit operate in parallel to the parameter decode unit and the data decode unit.

5. The decoding device according to claim 1, wherein the data decode unit performs decoding of context-based adaptive variable length coding (CAVLC).

6. An information reproducing apparatus for reproducing at least one of picture data and sound data, comprising:
a division processing unit that extracts a first transport stream (TS) packet for generating picture data, a second TS packet for generating sound data, and a third TS packet other than the first and second TS packets from a transport stream;
a memory having a first memory area in which the first TS packet is stored, and a second memory area in which the second TS packet is stored, and a third memory area in which the third TS packet is stored;
a picture decoder that performs picture decoding for generating the picture data based on the first TS packet read from the first memory area; and
a sound decoder that performs sound decoding for generating the sound data based on the second TS packet read from the second memory area; wherein:
the picture decoder including the decoding device according to claim 1;
the picture decoder reads the first TS packet from the first memory area independently of the sound decoder and performs the picture decoding based on the first TS packet; and
the sound decoder reads the second TS packet from the second memory area independently of the picture decoder and performs the sound decoding based on the second TS packet.

7. An electronic apparatus, comprising:
the information reproducing apparatus according to claim 6; and
a host that instructs the information reproducing apparatus to start at least one of the picture decoding and the sound decoding.

8. An electronic apparatus, comprising:
a tuner;
the information reproducing apparatus according to claim 6 to which a transport stream from the tuner is supplied; and
a host that instructs the information reproducing apparatus to start at least one of the picture decoding and the sound decoding.
